(19) United States
(12) Patent Application Publication
(10) Pub. No.: US 2018/0197226 A1
(43) Pub. Date: Jul. 12, 2018

(54) NON-TRANSITORY COMPUTER-READABLE STORAGE MEDIUM, INFORMATION PROCESSING APPARATUS AND METHOD

(71) Applicant: FUJITSU LIMITED, Kawasaki-shi (JP)

(72) Inventor: Mai Kobayashi, Kurashiki (JP)

(73) Assignee: FUJITSU LIMITED, Kawasaki-shi (JP)

(21) Appl. No.: 15/846,363

(22) Filed: Dec. 19, 2017

(30) Foreign Application Priority Data
Jan. 6, 2017 (JP) 2017-001143

(51) Int. Cl. G06Q 30/06; G06K 9/00; G06K 9/46; G06T 11/60

(52) U.S. Cl. CPC G06Q 30/0631; G06Q 30/0643; G06Q 50/01; G06K 9/4652; G06T 11/60; G06K 9/00671

(57) ABSTRACT

A non-transitory computer-readable storage medium storing a program that causes an information processing apparatus to execute a process, the process includes obtaining a captured image in which an object person is included, identifying a color classification corresponding to the object person based on the captured image, obtaining, from a first storage unit that stores color information corresponding to the identified color classification, the color information corresponding to the color classification, executing an obtaining processing for obtaining, from a second storage unit that stores an item and the color information while being associated with each other, item information indicating the item associated with the color information corresponding to the identified color classification, and outputting the obtained item information.

### CROSS-REFERENCE TO RELATED APPLICATION

This application is based upon and claims the benefit of priority of the prior Japanese Patent Application No. 2017-001143, filed on Jan. 6, 2017, the entire contents of which are incorporated herein by reference.

### FIELD

The embodiments discussed herein are related to a non-transitory computer-readable storage medium, an information processing apparatus and a method.

### BACKGROUND

Individuals select an item in various scenes. For example, individuals purchase an item as a product and select a target item when an item is borrowed. With regard to some items such as clothing and goods installed in a living space, harmonization with a person who puts on the item and other goods is taken into consideration when a customer makes the selection. For example, when clothing is considered as an example of the item, the customer determines whether or not the clothing as a selection candidate is suited to the person who puts on this clothing and whether or not the clothing is suited to the other clothing put on together. In view of the above, a method of supporting the above-mentioned determination by an information processing technology is conceivable.

For example, a fashion coordinate supporting apparatus has been proposed in which a fashion tendency of a user is estimated from user information on the internet, and coordinate information is provided based on information of the estimated fashion tendency of the user. The fashion coordinate supporting apparatus obtains user information on a social networking service (SNS) site or comment information written by the user on a shopping site as the user information and uses the user information to estimate the fashion tendency.

In addition, a system has been proposed in which a selection of a single or two or more of items by the user is accepted, and a reference is made to combination pattern information indicating whether or not a combination of the items is accepted as a coordinate, and a coordinate including all of the selected items is extracted. Related art literatures include Japanese Laid-open Patent Publication No. 2015-72639 and Japanese Laid-open Patent Publication No. 2010-182051.

### SUMMARY

According to an aspect of the invention, a non-transitory computer-readable storage medium storing a program that causes an information processing apparatus to execute a process, the process includes obtaining a captured image in which an object person is included, identifying a color classification corresponding to the object person based on the captured image, obtaining, from a first storage unit that stores color information corresponding to the identified color classification, the color information corresponding to the color classification, executing an obtaining processing for obtaining, from a second storage unit that stores an item and the color information while being associated with each other, item information indicating the item associated with the color information corresponding to the identified color classification, and outputting the obtained item information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a recommended item output apparatus according to a first exemplary embodiment.

FIG. 2 is a flow chart illustrating a recommended item output example according to the first exemplary embodiment.

FIG. 3 illustrates an output control apparatus according to a second exemplary embodiment.

FIG. 4 is a flow chart illustrating an output control example according to the second exemplary embodiment.

FIG. 5 illustrates an example of an information processing system according to a third exemplary embodiment.

FIG. 6 illustrates a hardware example of a terminal apparatus according to the third exemplary embodiment.

FIG. 7 illustrates a hardware example of a server according to the third exemplary embodiment.

FIG. 8 illustrates a function example according to the third exemplary embodiment.

FIG. 9 illustrates an example of a personal color correspondence table according to the third exemplary embodiment.

FIG. 10 illustrates an example of a color master according to the third exemplary embodiment.

FIG. 11 illustrates an example of a design master according to the third exemplary embodiment.

FIG. 12 illustrates an example of a body type master according to the third exemplary embodiment.

FIG. 13 illustrates an example of a color coordinate correspondence table according to the third exemplary embodiment.

FIG. 14 illustrates an example of a design coordinate correspondence table according to the third exemplary embodiment.

FIG. 15 illustrates an example of a product master according to the third exemplary embodiment.

FIG. 16 illustrates an example of a product category master according to the third exemplary embodiment.

FIG. 17 illustrates an example of a gender master according to the third exemplary embodiment.

FIG. 18 illustrates an example of screen transition (part 1) according to the third exemplary embodiment.

FIG. 19 illustrates an example of the screen transition (part 2) according to the third exemplary embodiment.

FIG. 20 illustrates an example of the screen transition (part 3) according to the third exemplary embodiment.

FIG. 21 illustrates an example of the screen transition (part 4) according to the third exemplary embodiment.

FIG. 22 illustrates an example of the screen transition (part 5) according to the third exemplary embodiment.

FIG. 23 illustrates an example of the screen transition (part 6) according to the third exemplary embodiment.

FIG. 24 is a flow chart illustrating a processing example of the terminal apparatus according to the third exemplary embodiment.

FIG. 25 is a flow chart illustrating a recommended item search example according to the third exemplary embodiment.

FIG. 26 is a flow chart illustrating a body type determination example according to the third exemplary embodiment.

FIG. 27 illustrates a terminal use example according to the third exemplary embodiment.

FIGS. 28A and 28B illustrate an example of size estimation according to the third exemplary embodiment.

FIG. 29 illustrates another example of display contents according to the third exemplary embodiment.

### DESCRIPTION OF EMBODIMENTS

When individuals select an item, a color of the item is taken into consideration. However, when individuals select a color of the item, it is not easy to appropriately determine a color harmonized with the person who tries on the item or colors of other goods. Since a quantitative determination is not performed by relying on a human perception, there is a possibility that an objectively harmonizing color is not appropriately determined. In view of the above, an issue occurs on how a scheme for performing an item selection support taking the color into consideration is realized.

Hereinafter, exemplary embodiments of the present disclosure will be described with reference to the drawings.

### First Exemplary Embodiment

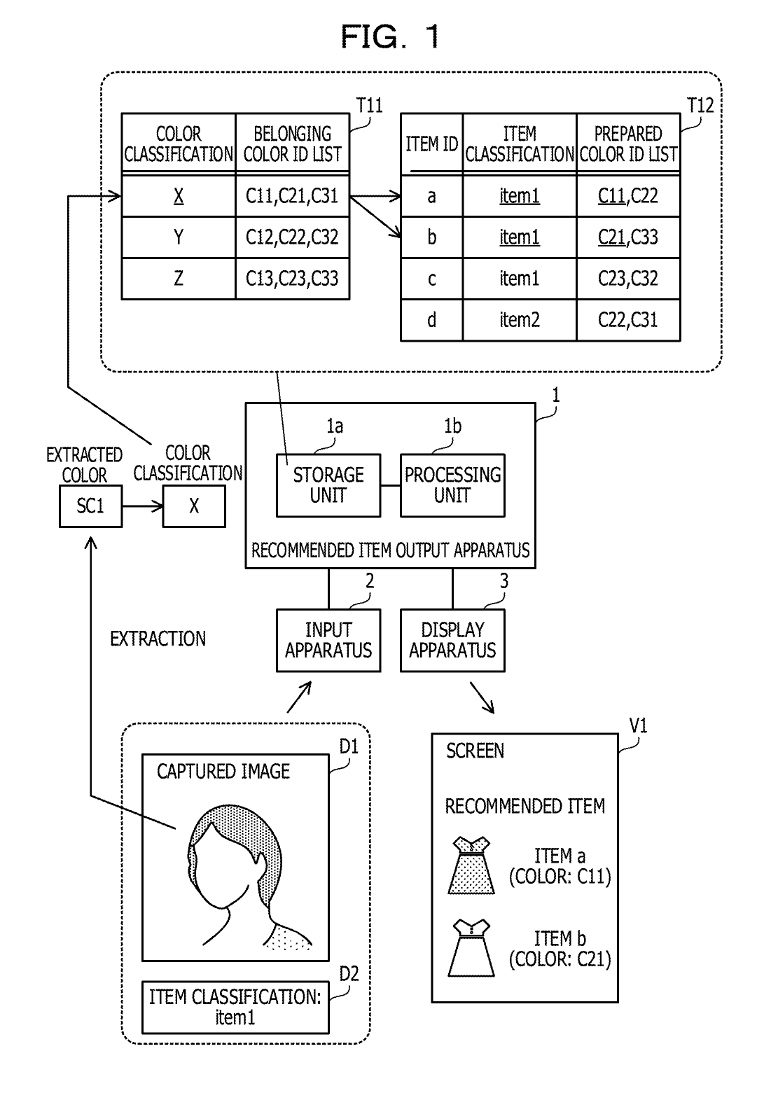

FIG. 1 illustrates a recommended item output apparatus according to a first exemplary embodiment. When a user selects an item, a recommended item output apparatus 1 supports a selection of a color suited to an object person (user itself or another person) who tries on the item. The “item” may be represented as goods, article, product, or the like. Examples of the items set as targets to be selected include clothing that people put on, shoes, and small articles (for example, bags and accessories).

The recommended item output apparatus 1 is coupled to an input apparatus 2 and a display apparatus 3. The input apparatus 2 accepts an operation input by the user. The input apparatus 2 is, for example, a touch panel or a pointing device such as a mouse. The display apparatus 3 is a display that displays a graphical user interface (GUI). For example, while the user operates the GUI displayed by the display apparatus 3 by using the input apparatus 2, the user can perform a predetermined input to the recommended item output apparatus 1. The recommended item output apparatus 1 may have the input apparatus 2 and the display apparatus 3 built therein. For example, the recommended item output apparatus 1 may be a smart device such as a smart phone or a tablet terminal having the input apparatus 2 and the display apparatus 3 built therein. Furthermore, the recommended item output apparatus 1 may also include an imaging apparatus that captures an image of an object person.

The recommended item output apparatus 1 includes a storage unit la and a processing unit 1b. The storage unit 1a may be a volatile storage device such as a random access memory (RAM) or a non-volatile storage device such as a hard disk drive (HDD) or a flash memory. The processing unit 1b may include a central processing unit (CPU), a digital signal processor (DSP), an application specific integrated circuit (ASIC), a field programmable gate array (FPGA), or the like. The processing unit 1b may be a processor that executes a program. The “processor” may include a set of a plurality of processors (multiprocessor).

The storage unit 1a stores a color classification table T11 and an item table T12.

The color classification table T11 is a table indicating color classifications and colors belonging to the color classifications. The color classification may be, for example, a classification based on a concept called “personal color”.

The personal color refers to a color that is harmonized with individual natural color of a skin, eyes, and hair, elicits its own characteristics, and makes the most of the attraction. The personal color may also be mentioned as a “suited color” to the object person. When the color that the individual has is classified into one of a plurality of groups, another color harmonized with the color that the individual has is determined in a diagnosis of the personal color. Herein, a color harmonized with the skin color (color blended with the skin) will be considered as the personal color.

For example, the color classification table T11 includes items of a color classification and a belonging color identifier (ID) list. The color classification is a name of the color classification. The belonging color ID list is a list of color IDs indicating personal colors belonging to the color classification (suited color with respect to the object person which is classified into the color classification). For example, a record of a color classification “X” and belonging color ID list “C11, C21, and C31” in the color classification table T11 indicates that three types of colors indicated by the color IDs “C11, C21, and C31” are the personal colors with respect to the object person classified into the color classification “X”. Herein, the color ID is identification information of the color. For example, the color is represented by a set of parameters “color value, brightness, and saturation”. The color may also be represented by a set of another parameter such as a set “R (Red), G (Green), and B (Blue)” or a set “hue, color value, and saturation”.

The item table T12 is a table indicating information of items that may be set as candidates to be selected by the user. For example, the item table T12 includes items of an item ID, an item classification, and a prepared color ID list. The item ID is identification information of the item. The item classification is a classification of the item. For example, in a case where the selection candidate is clothing that the object person puts on, classifications based on wearing regions such as outerwear, tops, and bottoms are conceivable as the classifications for the items. The prepared color ID list is a list of color IDs of colors prepared for the item. For example, a record of an item ID “a”, an item classification “items”, and prepared color ID list “C11 and C22” in the item table T12 indicates that the item having the item ID “a” belongs to the item classification “items”. In addition, the record indicates that a color having the color ID “C11” and a color having the color ID “C22” are prepared with respect to the item having the item ID “a”.

The processing unit 1b executes recommended item output processing based on the information stored in the storage unit 1a. Specifically, the processing is executed as follows.

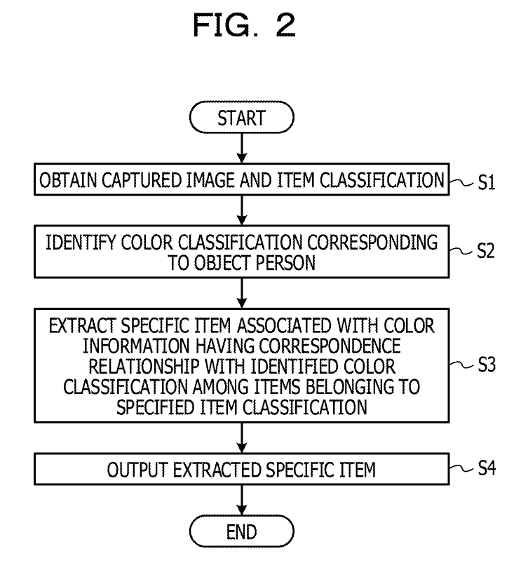

FIG. 2 is a flow chart illustrating a recommended item output example according to the first exemplary embodiment. Hereinafter, the processing illustrated in FIG. 2 will be described along step numbers.

(S1) The processing unit 1b obtains a captured image D1 including the object person and a specified item classification D2. The captured image D1 is a captured image captured by a predetermined imaging apparatus (which may also be an imaging apparatus built in the recommended item output apparatus 1) and includes an image of the object person. In a case where a skin color is used as the color that the object person has, the captured image D1 includes, for example, an image of the face of the object person. The item classification D2 includes, for example, information of the item classification “items 1”. For example, the user can input a file name of the captured image D1 and information of the item classification D2 to the recommended item output apparatus 1 by operating the input apparatus 2. In addition, in a case where the recommended item output apparatus 1 has a built-in imaging apparatus, the user can generate the captured image D1 including the object person by the imaging apparatus by operating the input apparatus 2. The processing unit 1b stores the obtained captured image D1 and the information of the item classification D2 in the storage unit 1a.

(S2) The processing unit 1b identifies the color classification corresponding to the object person based on the captured image D1. For example, the processing unit 1b extracts a skin color of the object person from the captured image D1 and identifies the color classification corresponding to the object person based on the skin color. Various methods are conceivable as an extraction method for the skin color. For example, the processing unit 1b may accept a specification of a region equivalent to the skin color in the captured image D1 by the user and extract information of the color included in this region as information of the skin color. In addition, the processing unit 1b may detect a face region of the object person from the captured image D1 by using a facial recognition technology and extract information of the color included in this region as the information of the skin color. Furthermore, in a case where a plurality of colors are included in the relevant region, the processing unit 1b may extract a color having a highest abundance ratio in this region as the information of the skin color. The processing unit 1b may use a method described in Japanese Laid-open Patent Publication No. 2015-184906 for detecting the skin color.

For example, it is presumed that the processing unit 1b extracts a color having a color ID “SC1” as the skin color of the object person. Then, the processing unit 1b identifies the color classification “X” corresponding to the color having the color ID “SC1”. Herein, information of a correspondence relationship between the skin color and the color classification is previously stored in the storage unit 1a. The information of the correspondence relationship between the skin color and the color classification may be determined based on the concept of the personal color as described above. The processing unit 1b identifies the color classification “X” corresponding to the color having the color ID “SC1” by referring to the information of the correspondence relationship between the skin color and the color classification stored in the storage unit 1a.

(S3) The processing unit 1b refers to the storage unit 1a where the color information is stored while being associated for each item and extracts a specific item associated with the color information having the correspondence relationship with the identified color classification among the items belonging to a specified item classification. For example, the processing unit 1b can extract the specific item based on the color classification table T11 and the item table T12 stored in the storage unit 1a.

More specifically, the processing unit 1b searches the records in the color classification table T11 by using the color classification “X” identified with respect to the object person as a key and obtains the belonging color ID list “C11, C21, and C31”. Furthermore, the processing unit 1b searches the records in the item table T12 by using the specified item classification “items” and the obtained color ID “C11” as the key and obtains the item ID “a”. The processing unit 1b searches the records in the item table T12 by using the item classification “item1” and the color ID “C21” as the key and obtains an item ID “b”. The processing unit 1b searches the records in the item table T12 by using the item classification “item1” and the color ID “C31” as the key but does not obtain any item ID with respect to this key. In this case, items respectively belonging to the item IDs “a” and “b” are specific items associated with the color information (color IDs “C11” and “C21”) having the correspondence relationship with the identified color classification “X” among the items belonging to the specified item classification “item1”.

(S4) The processing unit 1b outputs the extracted specific items as items recommended to the object person. For example, the processing unit 1b outputs information of the item corresponding to the item ID “a” and the item corresponding to the item ID “b” to the display apparatus 3 and causes the display apparatus 3 to display a display screen V1 including the information of the items. A name of the item, a color image of the item, a name of a color indicated by the color image, and the like are conceivable as the information of the items output by the processing unit 1b, for example. In addition, the processing unit 1b may provide an input interface for performing selection while the displayed item is set as a target of purchase (or sale), borrowing (or lending) or the like on the display screen V1.

In this manner, the recommended item output apparatus 1 outputs the item having the suited color to the object person as the recommended item.

Herein, when individuals select a color of the item, it is not easy to appropriately determine a color harmonized with the person who tries on the item or colors of other goods. A quantitative determination is not performed by relying on a human perception. In addition, a selection result may be changed by an individual subjectivity (personal preference, mood at the moment, or the like) when it depends on a human sense. Accordingly, there is a possibility that an objectively harmonizing color is not appropriately determined by the determination of the person.

In view of the above, the recommended item output apparatus 1 previously stores the color classification table T11 and the item table T12. Subsequently, the recommended item output apparatus 1 extracts the item having the suited color with respect to the object person based on the color classification table T11, the item table T12, and the input captured image D1 and outputs the item as the recommended item. As a result, it becomes possible to support the appropriate selection of the objectively harmonizing color with respect to the object person. In addition, it is possible to avoid compelling the user (or the object person) to perform the determination at the time of the color selection, and it is possible to save labor in the selection operation by the user.

The recommended item output apparatus 1 may be installed in a shop where sale, lending, or the like of clothing or the like is performed and may be used for the proposal of the clothing, small articles, or the like to the customer by a shop assistant. With this configuration, it becomes possible to easily perform the product proposal to the customer by the shop assistant. In addition, it is possible to reduce the number of trial fittings by the customer (for example, wedding dresses, kimonos, or the like) and also reduce costs for the trial fittings.

The recommended item output apparatus 1 may be a smart device used by the user as described above. For example, the recommended item output apparatus 1 may communicate with a server computer in a shop where sale, lending, or the like of clothing or the like is performed and may be used for online shopping by the user. When the item having the suited color is presented to the user, it is possible to suppress the misconception on colors by the user and reduce the number of returns due to the misconception on colors.

It is noted that the processing unit 1b may identify a color of a specified part in the captured image D1 and extract a specific item having associated with the color information having a correspondence relationship with a set of the identified color classification and the color of the identified part among the items belonging to the specified item classification D2 in addition to the above-mentioned processing. At this time, the processing unit 1b may extract information of the color included in the region specified by the user operation in the captured image D1. For example, it is conceivable that the processing unit 1b displays the captured image D1 and a frame overlapped on the captured image D1 and accepts inputs for movement and size change (also including a deformation) of the frame by the user to extract information of a color included in a region surrounded by the frame.

As a result, for example, an item having a high affinity color with respect to the color of the item set as the coordinate target selected by the object person among the personal colors of the object person can be presented as the recommended item.

In addition, for example, it is conceivable that the processing unit 1b determines a body type of the object person based on the captured image D1. In this case, the storage unit 1a further stores information of a correspondence relationship between the color information and the body type of the user. Subsequently, the processing unit 1b may refer to the storage unit 1a and extract the specific item associated with the color information having the correspondence relationships with both the identified color classification and the body type of the object person among the items belonging to the specified item classification D2.

As a result, for example, the item having the color suited to the body type of the object person among the personal colors of the object person can be presented as the recommended item.

Alternatively, the storage unit 1a may store first information in which the color information and design information are associated with each other and second information in which the design information and the body type of the user are associated with each other for each item. Subsequently, the processing unit 1b may refer to the storage unit 1a and extract the specific item associated with both the color information having the correspondence relationship with the identified color classification and the design information corresponding to the body type of the object person among the items belonging to the specified item classification D2.

As a result, for example, the item having both the personal color of the object person and the design suited to the body type of the object person can be presented as the recommended item.

Furthermore, the storage unit 1a may store information of a combination of high affinity designs. Subsequently, the processing unit 1b may identify a first design of the specified part in the captured image D1 and identify a second design corresponding to the first design based on the information of the combination of the high affinity designs stored in the storage unit 1a. Thereafter, the processing unit 1b may extract the specific item associated with both the color information having the correspondence relationship with the identified color classification and the design information corresponding to the second design among the items belonging to the specified item classification D2 based on the first information stored in the storage unit 1a.

As a result, for example, the item having both the personal color of the object person and the design having the high affinity with respect to the design of the item of the coordinate target selected by the object person can be presented as the recommended item.

### Second Exemplary Embodiment

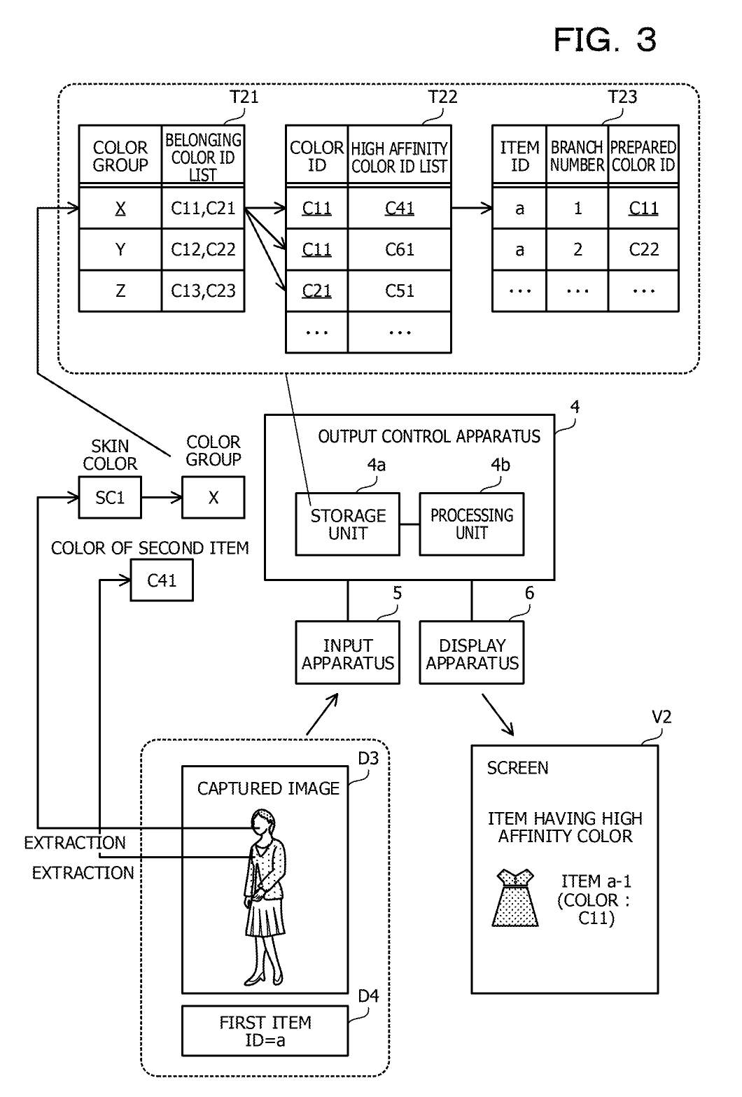

FIG. 3 illustrates an output control apparatus according to a second exemplary embodiment. When the user selects an item, an output control apparatus 4 supports a selection of a color suited to both an object person (user itself or another person) who tries on the item and another item used by the object person. Examples of the items include clothing that people put on, shoes, and small articles (for example, bags and accessories).

The output control apparatus 4 is coupled to an input apparatus 5 and a display apparatus 6. The input apparatus 5 accepts an operation input by the user. The input apparatus 5 is, for example, a touch panel or a pointing device such as a mouse. The display apparatus 6 is a display that displays a graphical user interface (GUI). For example, while the user operates the GUI displayed by the display apparatus 6 by using the input apparatus 5, the user can perform a predetermined input to the output control apparatus 4. The output control apparatus 4 may have the input apparatus 5 and the display apparatus 6 built therein. For example, the output control apparatus 4 may be a smart device such as a smart phone or a tablet terminal having the input apparatus 5 and the display apparatus 6 built therein. Furthermore, the output control apparatus 4 may also include an imaging apparatus that captures an image of an object person.

The output control apparatus 4 includes a storage unit 4a and a processing unit 4b. The storage unit 4a may be a volatile storage device such as a RAM or a non-volatile storage device such as an HDD or a flash memory. The processing unit 4b may include a CPU, a DSP, an ASIC, a FPGA, or the like. The processing unit 4b may be a processor that executes a program. The “processor” may include a set of a plurality of processors (multiprocessor).

The storage unit 4a stores a color group table T21, a coordinate correspondence table T22, and an item table T23.

The color group table T21 is a table indicating a color group and colors belonging to the color group. The color group may be, for example, a group (color classification) based on the above-mentioned “personal color” concept.

For example, the color group table T21 includes items of a color group and a belonging color ID list. The color group is a name of the color group. The belonging color ID list is a list of color IDs indicating personal colors belonging to the color group. For example, a record of a color group “X” and a belonging color ID list “C11 and C21” in the color group table T21 indicates that two types of colors indicated by the color IDs “C11 and C21” are the personal colors with respect to the object person classified into the color group “X”. Herein, the color is represented by a set of parameters such as “color value, brightness, and saturation” as described above.

The coordinate correspondence table T22 is a table indicating a color (high affinity color) having the high affinity with respect to a certain color.

For example, the coordinate correspondence table T22 includes items of a color ID and a high affinity color ID list. The color ID is identification information of a color. The high affinity color ID list is a list of color IDs having the high affinity with respect to a color corresponding to the color ID set in the item of the color ID. For example, a record of the color ID “C11” and a high affinity color ID list “C41” in the coordinate correspondence table T22 indicates that a high affinity color with respect to a color having the color ID “C11” is a color having the color ID “C41”.

The item table T23 is a table indicating information of items that may be set as candidates to be selected by the user. For example, the item table T23 includes items of an item ID, a branch number, and a prepared color ID. The item ID is identification information of an item. The branch number is a branch number of the item. The branch number of the item is assigned for each color (prepared color) prepared with respect to a certain item. The prepared color ID is identification information of a prepared color with respect to this item. For example, a record of an item ID “a”, a branch number “1”, a prepared color ID “C11” in the item table T23 indicates that a prepared color with respect to the item indicated by the item ID “a” and the branch number “1” is a color having the prepared color ID “C11”.

The processing unit 4b executes output control processing based on the information stored in the storage unit 4a. Specifically, the processing is as follows.

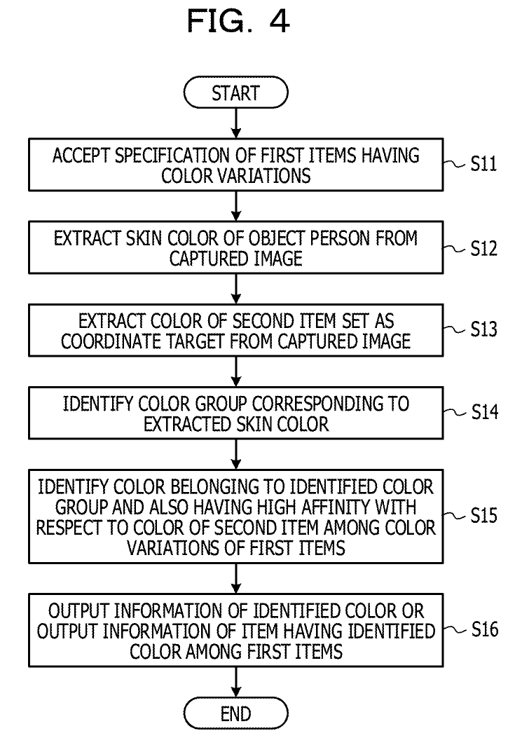

FIG. 4 is a flow chart illustrating an output control example according to the second exemplary embodiment. Hereinafter, the processing illustrated in FIG. 4 will be described along step numbers.

(S11) The processing unit 4b accepts an input of a captured image D3 and a specification D4 of a first item having color variations. The captured image D3 is a captured image captured by a predetermined imaging apparatus (which may be an imaging apparatus built in the output control apparatus 4) and includes, for example, a full-length image of the object person. The first item specification D4 includes, for example, the item ID “a” of the first item. In the example according to the second exemplary embodiment, the first item corresponding to the item ID “a” has color variations such as the color having the color ID “C11” and the color having the color ID “C22”. For example, the user can input a file name of the captured image D3 and the first item specification D4 to the output control apparatus 4 by operating the input apparatus 5. In addition, in a case where the output control apparatus 4 has the imaging apparatus built therein, the user can also generate the captured image D3 including the object person by this imaging apparatus by operating the input apparatus 5. The processing unit 4b stores the obtained captured image D3 and information of the first item specification D4 in the storage unit 4a.

It is noted that the first item specification D4 may be a specification of an item type. For example, the processing unit 4b may accept the specification of the item type such as “tops”, “T-shirts”, or “jackets”. In this case, it is conceivable that identification information of a plurality of items belonging to the specified item type is specified (the processing unit 4b executes the following procedure with respect to the identification information of the individual items).

(S12) The processing unit 4b extracts the skin color of the object person from the captured image D3. For example, the processing unit 4b may accept a specification of the region equivalent to the skin color in in the captured image D3 by the user and extract information of a color included in the region as the information of the skin color. In addition, the processing unit 4b may detect the face region of the object person from the captured image D3 by using the facial recognition technology and extract the information of the color included in the region as the information of the skin color. Furthermore, in a case where a plurality of colors are included in the relevant region, the processing unit 4b may extract a color having a highest abundance ratio in this region as the information of the skin color. The processing unit 4b may use a method described in Japanese Laid-open Patent Publication No. 2015-184906 for detecting the skin color.

(S13) The processing unit 4b extracts a color of a second item of the coordinate target from the captured image. For example, the processing unit 4b may accept a specification of a region equivalent to the color of the second item in the captured image D3 by the user and extract the information of the color included in the region as the information of the color of the second item. In a case where a plurality of colors are included in the relevant region, the processing unit 4b may also extract a color having a highest abundance ratio in this region as the information of the color of the second item. For example, it is presumed that the processing unit 4b extracts the color having the color ID “C41” as the color of the second item. Alternatively, in a case where a plurality of colors are included in the relevant region, the plurality of colors may be extracted as the information of the color of the second item.

Herein, the “coordinate” refers to a combining activity of a plurality of clothes, small articles, and the like such that colors and designs are harmonized with each other in the field of clothing, interior, and the like. In addition, the “item of the coordinate target” refers to an item that the user is considering to put on, use, or arrange (for example, an item already owned by the user) in combination with the item of the selection target.

(S14) The processing unit 4b identifies the color group corresponding to the extracted skin color. For example, in step S12, it is presumed that the processing unit 4b extracts the color having the color ID “SC1” as the skin color of the object person. Then, the processing unit 4b identifies the color group “X” corresponding to the color having the color ID “SC1”. Herein, information of a correspondence relationship between the skin color and the color group is previously stored in the storage unit 4a. The information of the correspondence relationship between the skin color and the color group may be determined based on the concept of the personal color. The processing unit 4b refers to the information of the correspondence relationship between the skin color and the color group which is stored in the storage unit 4a to identify the color group “X” corresponding to the color having the color ID “SC1”

(S15) The processing unit 4b identifies a color belonging to the identified color group and also having the high affinity with respect to the color of the second item among the color variations of the first items. Specifically, the processing unit 4b identifies the color having the high affinity with respect to the color of the second item based on the color group table T21, the coordinate correspondence table T22, and the item table T23 stored in the storage unit 4a.

That is, the processing unit 4b searches the records in the color group table T21 by using the identified color group “X” as a key with respect to the object person and obtains the belonging color ID list “C11 and C21”. Then, the processing unit 4b refers to the coordinate correspondence table T22 and checks that the color ID “C41” extracted in step S13 is registered in the high affinity color ID list with respect to the obtained color ID “C11”. On the other hand, the processing unit 4b refers to the coordinate correspondence table T22 and checks that the color ID “C41” extracted in step S13 is not registered in the high affinity color ID list with respect to the obtained color ID “C21”. In this case, the color having the color ID “C21” is excluded from the recommended candidate. Furthermore, the processing unit 4b searches the records in the item table T23 by using the color ID “C11” as a key and obtains the record of the item ID “a” and the branch number “1”. In this case, a color belonging to the color group “X” and also having the high affinity with respect to the color of the second item “C41” among the color variations of the first items (such as the color having the color ID “C11” and the color having the color ID “C22”) is the color having the color ID “C11”.

It is noted that, in a case where the processing unit 4b may extract a plurality of colors as the color of the second item in step S13 and identify a color having the high affinity with respect to the plurality of colors. In this case, it is conceivable that a color having the high affinity with respect to one color among the plurality of colors is identified, and it is also conceivable that a color having the high affinity with respect to all the colors of the plurality of colors is identified.

(S16) The processing unit 4b outputs information of the identified color. Alternately, the processing unit 4b outputs information of the item having the identified color among the first items. For example, the processing unit 4b outputs the identified color ID “C11” as information of the color in step S15. Alternatively, the processing unit 4b outputs a set of the item ID “a” corresponding to the item having the identified color and the branch number “1” among the first items as the information of the item having the identified color.

For example, the processing unit 4b outputs information of the item corresponding to a set “a-1” of the item ID “a” and he branch number “1” to the display apparatus 6 and causes the display apparatus 6 to display a display screen V2 including the information of the item. A name of the item, a color image of the item, a name of a color indicated by the color image, and the like are conceivable as the information of the items output by the processing unit 4b, for example. The processing unit 4b may also include a message mentioning that the relevant color is a color having the high affinity with respect to both the object person and the second item in the display screen V2. In addition, the processing unit 4b may provide an input interface for performing selection while the displayed item is set as a target of purchase (or sale), borrowing (or lending) or the like on the display screen V2.

It is noted that, in step S13, the processing unit 4b extracts the color of the second item of the coordinate target from the captured image but may also allow a specification of the color ID for the color of the second item by the user. For example, the processing unit 4b may display a color palette including the plurality of colors by the display apparatus 6 and accept a selection input regarding the color of the second item of the coordinate target by the user.

In this manner, the output control apparatus 4 outputs the item having the high affinity with respect to the object person and the item of the coordinate target as the recommended item.

As a result, it becomes possible to support the appropriate selection of the objectively harmonizing color with respect to the object person. In addition, it is possible to avoid compelling the user (or the object person) to perform the determination at the time of the color selection, and it is possible to save labor in the selection operation by the user.

The output control apparatus 4 may be installed in a shop where sale, lending, or the like of clothing or the like is performed and may be used for the proposal of the clothing, small articles, or the like to the customer by the shop assistant. With this configuration, it becomes possible to easily perform the product proposal to the customer by the shop assistant. In addition, it is possible to reduce the number of trial fittings by the customer (for example, wedding dresses, kimonos, or the like) and also reduce costs for the trial fittings.

The output control apparatus 4 may be a smart device used by the user as described above. For example, the output control apparatus 4 may communicate with a server computer in a shop where sale, lending, or the like of clothing or the like is performed and may be used for online shopping by the user. When the item having the suited color is presented to the user, it is possible to suppress the misconception on colors by the user and reduce the number of returns due to the misconception on colors.

It is noted that processing by the processing unit 4b in the output control apparatus 4 can also be represented as follows. That is, the processing unit 4b accepts a specification of items having color variations. The processing unit 4b refers to the storage unit 4a that stores relationships of high affinity colors and identifies a color having the high affinity with respect to the single or the plurality of colors specified in the captured image D3 among the color variations. The processing unit 4b outputs information of the identified color or information of an item having the identified color among the items.

The above-described function of the output control by the output control apparatus 4 can be applied to not only a case where an item that a person puts on is selected but also a case where an item that an animal puts on is selected by a person, a case where an item to be installed in a living space is selected by a person, and the like.

Hereinafter, a case will be exemplified where the functions described by the recommended item output apparatus 1 according to the first exemplary embodiment and the output control apparatus 4 according to the second exemplary embodiment are applied to a product proposal service in a shop that sells clothing or the like, and the functions will be further described in detail.

### Third Exemplary Embodiment

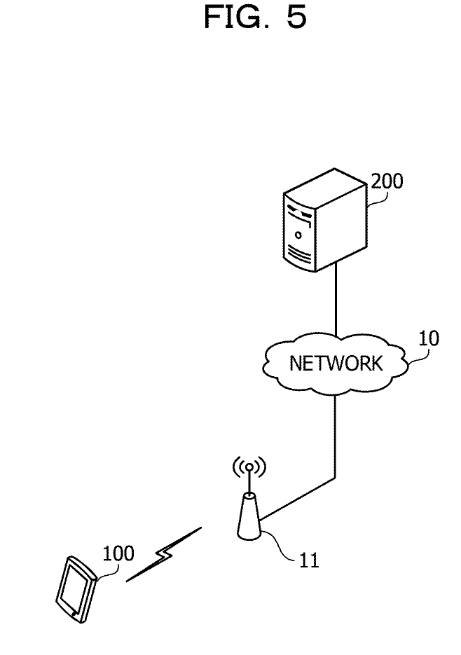

FIG. 5 illustrates an example of an information processing system according to a third exemplary embodiment. The information processing system according to the third exemplary embodiment provides a product proposal service in a shop that sells clothing, small articles, and the like. Products such as the clothing and the small articles are examples of items. The information processing system according to the third exemplary embodiment includes a terminal apparatus 100 and a server 200. The server 200 is coupled to a network 10. The terminal apparatus 100 is coupled to the network 10 via an access point 11 and communicates with the server 200.

The network 10 is, for example, the internet or a wide area network (WAN). The access point 11 may be an access point of a wireless local area network (LAN) or a base station coupled to a mobile communication network. In the latter case, the terminal apparatus 100 is coupled to the network 10 via the mobile communication network.

The terminal apparatus 100 is a client computer used by a user (for example, a shop assistant or a customer in a shop). The terminal apparatus 100 may also be a smart device such as a smart phone or a tablet terminal. The terminal apparatus 100 is an example of the recommended item output apparatus 1 according to the first exemplary embodiment. The terminal apparatus 100 is an example of the output control apparatus 4 according to the second exemplary embodiment.

The server 200 functions as a web server and is a server computer that provides a website where clothing recommendation is performed. The server 200 can also perform sale processing of the clothing selected by the user. Herein, it is presumed that the clothing of the sale target is clothing that a person puts on. It is noted however that, as will be described below, the clothing of the sale target may be clothing that an animal puts on or the like.

The terminal apparatus 100 and the server 200 support color selection based on the concept of “personal color”. According to the third exemplary embodiment, personal colors are classified into four seasons. The four seasons are spring, summer, autumn, and winter. Personal colors for a certain person are not necessarily colors that the person likes. In addition, the person itself does not realize its personal colors in many cases.

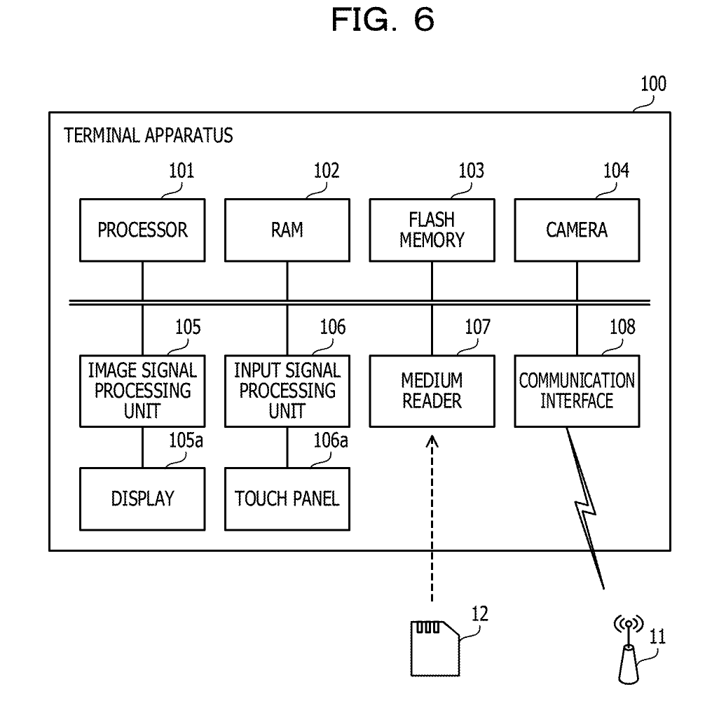

FIG. 6 illustrates a hardware example of a terminal apparatus according to the third exemplary embodiment. The terminal apparatus 100 includes a processor 101, a RAM 102, a flash memory 103, a camera 104, an image signal processing unit 105, a display 105a, an input signal processing unit 106, a touch panel 106a , a medium reader 107, and a communication interface 108. The respective hardware components are coupled to a bus of the terminal apparatus 100.

The processor 101 is hardware that controls information processing of the terminal apparatus 100. The processor 101 may be a multiprocessor. The processor 101 is, for example, a CPU, a DSP, an ASIC, an FPGA, or the like. The processor 101 may also be a combination of two or more elements of the CPU, the DSP, the ASIC, the FPGA, and the like.

The RAM 102 is a main storage device of the terminal apparatus 100. The RAM 102 temporarily stores at least part of programs of an operating system (OS) executed by the processor 101 and application programs. In addition, the RAM 102 stores various data used for processing by the processor 101

The flash memory 103 is an auxiliary storage device of the terminal apparatus 100. The flash memory 103 stores the programs of the OS, the application programs, and the various data.

The camera 104 is an imaging apparatus installed in the terminal apparatus 100. The camera 104 includes an imaging element such as a charge-coupled device (CCD) or a complementary metal oxide semiconductor (CMOS). The camera 104 generates data of a still image or a moving image of a scene at which a lens of the camera 104 is directed in accordance with a command from the processor 101. Herein, processing for the camera 104 to generate the data of the image by using the imaging element will be referred to as “capturing”, and image information generated by the capturing will be referred to as a “captured image”. In addition, processing for the user to cause the camera 104 to perform capturing by operating the terminal apparatus 100 will be referred to as “shooting”.

The image signal processing unit 105 outputs an image to the display 105a in accordance with the command from the processor 101. A liquid crystal display can be used as the display 105a, for example.

The input signal processing unit 106 obtains an input signal from the touch panel 106a coupled to the terminal apparatus 100 to be output to the processor 101. The touch panel 106a is a pointing device that outputs a position where the user performs a touch operation to the processor 101. The touch panel 106a is provided while being overlapped with a display region of the display 105a. The user can perform the touch operation based on the touch panel 106a while display by the display 105a is visually checked.

The medium reader 107 is an apparatus that reads a program or data stored in a recording medium 12. For example, a flash memory card can be used as the recording medium 12. The medium reader 107 stores the program or the data read from the recording medium 12 in the RAM 102 or the flash memory 103, for example, in accordance with the command from the processor 101

The communication interface 108 is a wireless communication interface that establishes a wireless link with the access point 11 and performs a communication with other apparatuses including the server 200 via the access point 11 and the network 10. It is noted however that the communication interface 108 may also be a wired communication interface that is coupled to the network 10 in a wired manner.

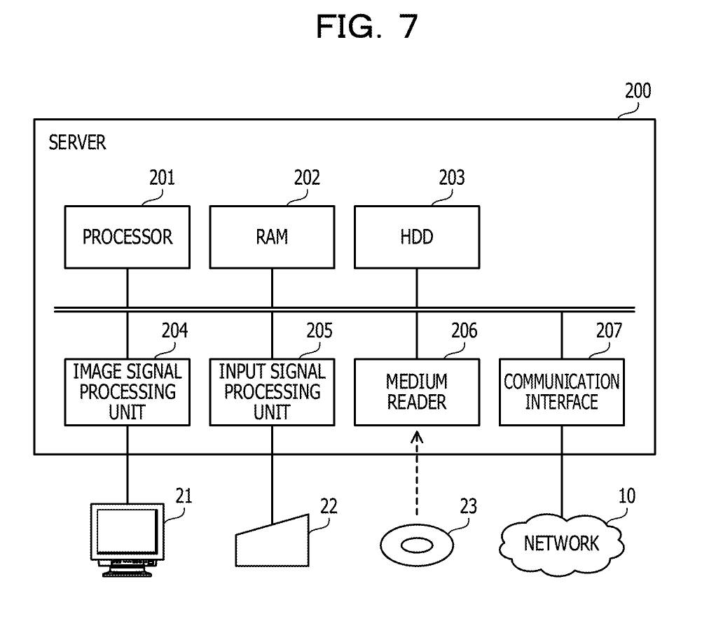

FIG. 7 illustrates a hardware example of a server according to the third exemplary embodiment. The server 200 includes a processor 201, a RAM 202, an HDD 203, an image signal processing unit 204, an input signal processing unit 205, a medium reader 206, and a communication interface 207. The respective hardware components are coupled to a bus of the server 200.

The processor 201 is hardware that controls information processing of the server 200. The processor 201 may be a multiprocessor. The processor 201 is, for example, a CPU, a DSP, an ASIC, an FPGA, or the like. The processor 201 may also be a combination of two or more elements of the CPU, the DSP, the ASIC, the FPGA, and the like.

The RAM 202 is a main storage device of the server 200. The RAM 202 temporarily stores at least part of programs of an OS executed by the processor 201 and application programs. In addition, the RAM 202 stores various data used for processing by the processor 201.

The HDD 203 is an auxiliary storage device of the server 200. The HDD 203 magnetically performs write and read of data with respect to a built-in magnetic disc. The HDD 203 stores the programs of the OS, the application programs, and the various data. The server 200 may include an auxiliary storage device of another type such as a solid state drive (SSD) and also include a plurality of auxiliary storage devices.

The image signal processing unit 204 outputs an image to a display 21 coupled to the server 200 in accordance with a command from the processor 201. A cathode ray tube (CRT) display, a liquid crystal display, or the like can be used as the display 21.

The input signal processing unit 205 obtains an input signal from an input device 22 coupled to the server 200 to be output to the processor 201. A pointing device such as a mouse or a touch panel, a key board, or the like can be used as the input device 22, for example.

The medium reader 206 is an apparatus that reads a program or data stored in a recording medium 23. For example, a magnetic disc such as a flexible disk (FD) or an HDD, an optical disc such as a compact disc (CD) or a digital versatile disc (DVD), or a magneto-optical disk (MO) can be used as the recording medium 23. In addition, a non-volatile semiconductor memory such as a flash memory card can also be used as the recording medium 23, for example. The medium reader 206 stores the program or the data read from the recording medium 23 in the RAM 202 or the HDD 203, for example, in accordance with the command from the processor 201.

The communication interface 207 performs a communication with other apparatuses including the terminal apparatus 100 via the network 10. The communication interface 207 may be a wired communication interface or may also be a wireless communication interface.

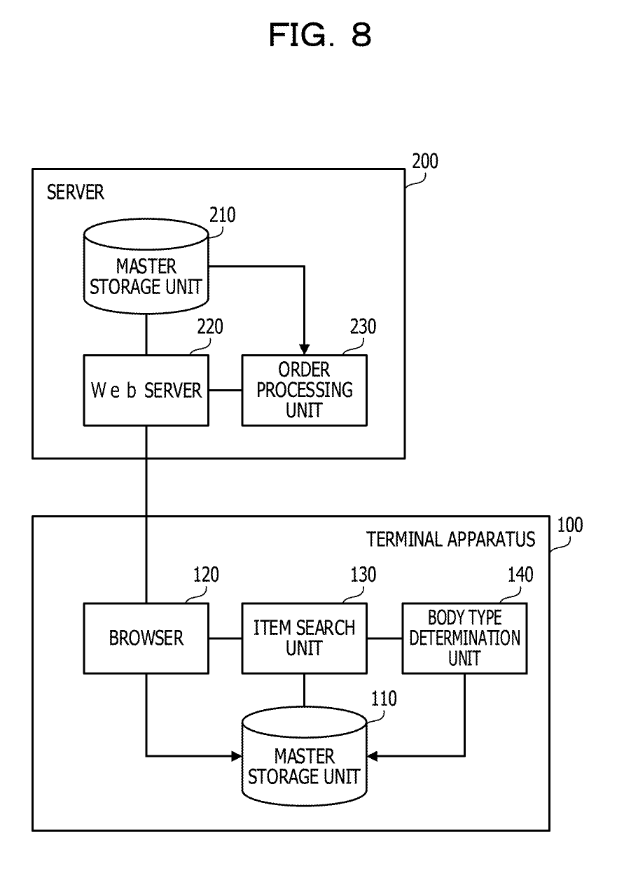

FIG. 8 illustrates a function example according to the third exemplary embodiment. The terminal apparatus 100 includes a master storage unit 110, a browser 120, an item search unit 130, and a body type determination unit 140. The master storage unit 110 is realized as a storage area secured in the RAM 102 or the flash memory 103. The browser 120, the item search unit 130, and the body type determination unit 140 are realized when the processor 101 executes the program stored in the RAM 102.

The browser 120, the item search unit 130 and the body type determination unit 140 may be implemented as a single application. Alternatively, an application for providing the function of the browser 120 and an application for providing the functions of the item search unit 130 and the body type determination unit 140 may be separate applications.

The master storage unit 110 stores master information downloaded from the server 200. The master information includes a personal color correspondence table, a color master, a design master, a body type master, a color coordinate correspondence table, a design coordinate correspondence table, a product master, a product category master, and a gender master.

The personal color correspondence table is information of correspondence relationships between seasons and skin color ranges. The color master is color definition information. According to the third exemplary embodiment, it is presumed that a color is represented by a combination of color value, brightness, and saturation as an example. It is noted however that the color may be represented by using another parameter (for example, a set of hue, color value, and saturation or the like). The design master is design definition information. The body type master is body type definition information. The color coordinate correspondence table is information of combinations of high affinity colors. The design coordinate correspondence table is information of combinations of high affinity designs. The product master is a table where basic information such as clothing and small articles corresponding to products is registered. The product category master is definition information of product categories to which the products belong. The gender master is gender definition information.

The browser 120 causes the display 105a to display the GUI of the website provided by the server 200. The browser 120 accepts the operation input by the user (for example, selection of an item, selection of a screen region, or the like) using the touch panel 106a with respect to the GUI displayed on the display 105a. For example, the browser 120 communicates with the server 200 by using Hypertext Transfer Protocol (HTTP) or Hypertext Transfer Protocol Secure (HTTPS) and obtains display information corresponding to the GUI of the website. The display information is, for example, HTML data including descriptions in Hypertext Markup Language (HTML), java script (registered trademark), or the like.

In addition, the browser 120 downloads the master information from the server 200 to be stored in the master storage unit 110. Furthermore, the browser 120 causes the item search unit 130 to execute a search of a recommended product (recommended item) and causes the display 105a to display the search result to support a product selection by the user.

The item search unit 130 determines the personal color of the customer based on the captured image of the customer and performs the search for the recommended products based on the personal color. Specifically, the item search unit 130 obtains a color or design of the clothing or the small article owned by the customer and performs the search for the recommended products based on the obtained color or design and the personal color. The item search unit 130 provides the search result of the recommended products to the browser 120. Furthermore, the item search unit 130 has a function of narrowing down the recommended products based on the body type of the customer. In a case where the recommended products are narrowed down based on the body type of the customer, the item search unit 130 requests the body type determination unit 140 to determine the body type of the customer. The item search unit 130 may also display a GUI for accepting an input for the item search on the display 105a in some cases.

It is noted that the server 200 may be provided with the function of the item search unit 130. In a case where the server 200 has the function of the item search unit 130, the server 200 obtains information for the item search from the browser 120 and transmits the item search result to the browser 120.

The body type determination unit 140 determines the body type of the customer based on the captured image of the customer. The body type determination unit 140 replies the determination result of the body type of the customer to the item search unit 130. The body type determination unit 140 may display a GUI for accepting an input for the body type determination on the display 105a in some cases.

It is noted that the server 200 may be provided with the function of the body type determination unit 140. In a case where the server 200 has the function of the body type determination unit 140, the server 200 obtains the information for the body type determination from the browser 120 and transmits the result of the body type determination to the browser 120. It is noted however that, in a case where the server 200 also has the function equivalent to the item search unit 130, the function equivalent to the body type determination unit 140 on the server 200 provides the result of the body type determination to the function equivalent to the item search unit 130 on the server 200.

The server 200 includes a master storage unit 210, a web server 220, and an order processing unit 230. The master storage unit 210 is realized as a storage area secured in the RAM 202 or the HDD 203. The web server 220 and the order processing unit 230 are realized when the processor 201 executes a program stored in the RAM 202.

The master storage unit 210 stores the master information provided to the terminal apparatus 100. In addition, the master storage unit 210 stores information (stock master) related to stock of products such as clothing. Furthermore, the master storage unit 210 stores information related to an order of the product accepted from the user.

The web server 220 provides the GUI of the website of the product proposal to the terminal apparatus 100. The web server 220 supports product purchase by the user in collaboration with the order processing unit 230. In addition, the web server 220 provides the master information stored in the master storage unit 210 to the browser 120.

Furthermore, the web server 220 provides a GUI for performing maintenance of the master information for an administrator of the website and accepts a maintenance operation of the master information by the administrator to update the master information stored in the master storage unit 210.

The order processing unit 230 performs sale processing of the clothing selected by the user. For example, the order processing unit 230 checks the stock of the clothing specified by the terminal apparatus 100. In addition, the order processing unit 230 registers identification information (product ID), size, quantity, and the like of the product ordered by the user in the master storage unit 210 while being associated with a user account.

Next, an example of the master information according to the third exemplary embodiment will be described.

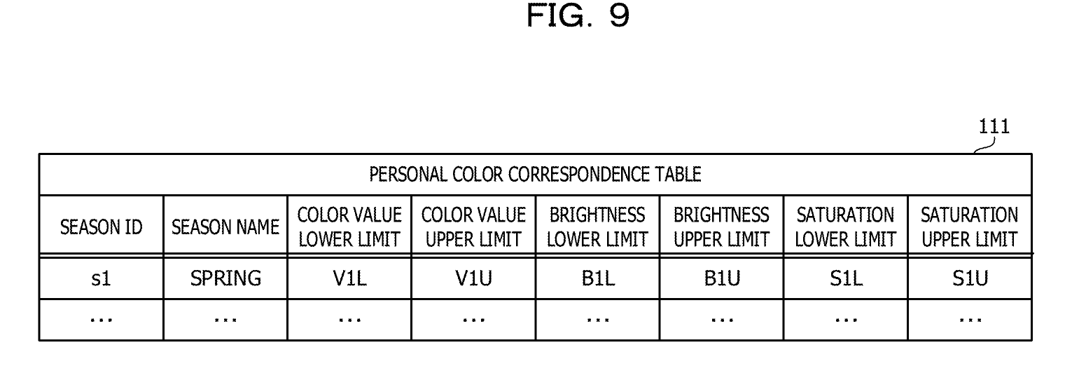

FIG. 9 illustrates an example of a personal color correspondence table according to the third exemplary embodiment. A personal color correspondence table 111 is stored in the master storage unit 110. The personal color correspondence table 111 includes items of a season ID, the season name, a color value lower limit, a color value upper limit, a brightness lower limit, a brightness upper limit, a saturation lower limit, and a saturation upper limit.

A season ID is registered in the item of the season ID. A name of the season is registered in the item of the season name. A lower value of a range for the color value is registered in the item of the color value lower limit. An upper value of the range for the color value is registered in the item of the color value upper limit. A lower value of a range for the brightness is registered in the item of the brightness lower limit. An upper value of the range for the brightness is registered in the item of the brightness upper limit. A lower value of a range for the saturation is registered in the item of the saturation lower limit. An upper value of the range for the saturation is registered in the item of the saturation upper limit.

For example, a record indicating that the season ID is “s1”, the season name is “spring”, the color value lower limit is “V1L”, the color value upper limit is “V1U”, the brightness lower limit is “B1L”, the brightness upper limit is “B1U”, the saturation lower limit is “S1L”, and the saturation upper limit is “S1U” is registered in the personal color correspondence table 111. This record indicates that the season name having the season ID “s1” is “spring”. In addition, it is indicated that the skin color range classified into the season name “spring” is the color value “V1L to V1U”, the brightness “B1L to B1U”, and the saturation “S1L to S1U”. That is, a color (color evaluated as the skin color) where the color value is in the range “V1L to V1U”, the brightness is in the range “B1L to B1U”, and also the saturation is in the range “S1L to S1U” is classified into the season having the season name “spring”.

The skin color ranges of the respective seasons including “summer”, “autumn”, and “winter” are also previously respectively registered in “spring” in the personal color correspondence table 111. Human skin colors have differences such as light skin colors and dark skin colors depending on individuals. For this reason, the skin color ranges are determined by the respective ranges of the color value, the brightness, and the saturation for the respective seasons as described above.

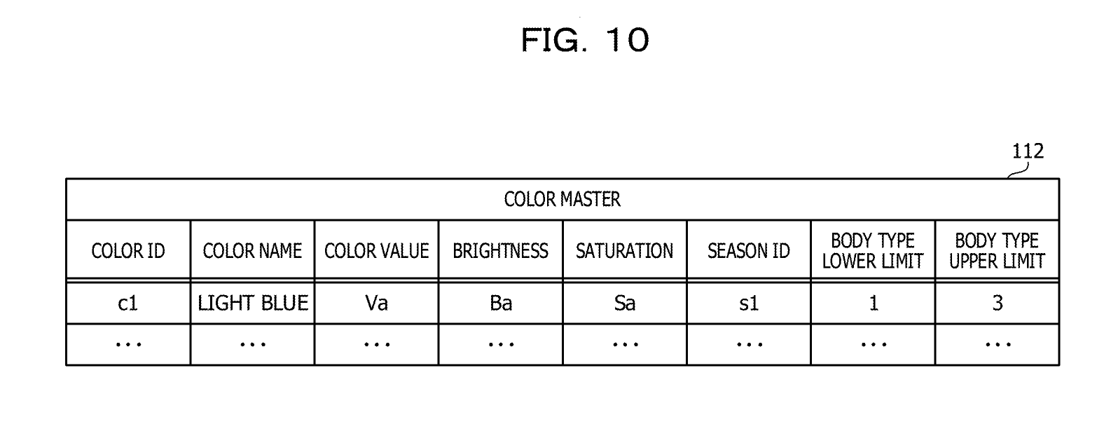

FIG. 10 illustrates an example of the color master according to the third exemplary embodiment. The color master 112 is stored in the master storage unit 110. The color master 112 includes items of the color ID, a color name, the color value, the brightness, the saturation, the season ID, a body type lower limit, and a body type upper limit.

The color ID is registered in the item of the color ID. The name of the color is registered in the item of the color name. The value of the color value is registered in the item of the color value. The value of the brightness is registered in the item of the brightness. The value of the saturation is registered in the item of the saturation. The season ID of the season to which the relevant color belongs is registered in the item of the season ID. A plurality of color IDs are associated with a single season ID (it can be mentioned that the color ID associated with the season ID is the color ID of the personal color corresponding to the season ID). A value indicating a lower limit of a high affinity body type with respect to the relevant color is registered in the item of the body type lower limit. A value indicating a higher limit of the high affinity body type with respect to the relevant color is registered in the item of the body type upper limit. Herein, the body type is identified by a number referred to as a body type category. With regard to a value of the body type category, 3 represents regular (standard body type). A lower value represents a slimmer body, and a higher value represents a heavier body.

For example, a record indicating that the color ID is “c1”, the color name is “light blue”, the color value is “Va”, the brightness is “Ba”, the saturation is “Sa”, the season ID is “s1”, the body type lower limit is “1”, and the body type upper limit is “3” is registered in the color master 112. This record indicates that the color name having the color ID “c1” is “light blue”. In addition, it is indicated that the color having the color name “light blue” is represented by a combination of the color value “Va”, the brightness “Ba”, and the saturation “Sa”, and the color belongs to the season (“spring”) having the season ID “1”. That is, “light blue” is the personal color of the person corresponding to the season “spring”. In addition, it is indicated that “light blue” has the high affinity with respect to individuals having the body type categories “1” to “3”.

Herein, colors have classifications such as a contractive color and an expansive color, for example. The contractive color is a relatively dark color, which makes a wearing person look small. On the other hand, the expansive color is a relatively pale color, which makes a wearing person look large. For this reason, it is considered that clothing having the contractive color has the high affinity with respect to a relatively heavy person (because the wearing person looks thinner on it). In addition, it is considered that clothing having the expansive color has the high affinity with respect to a relatively slim person. For example, a range of the body type category having the high affinity with respect to the color is previously registered in the color master 112 based on the above-described concept. It is noted that a color having high affinity with respect to all the body type categories also exists.

In addition, ranges of the respective values of the color value, the brightness, and the saturation may be registered in the color master with respect to the color ID. That is, a single personal color may also be defined as a color having a width to some extent similarly as in the skin color.

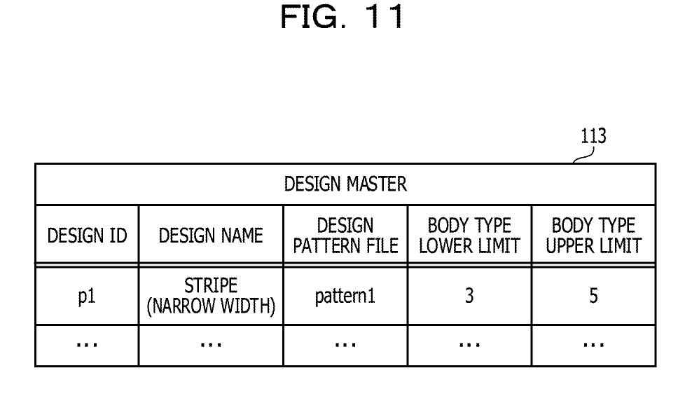

FIG. 11 illustrates an example of the design master according to the third exemplary embodiment. The design master 113 is stored in the master storage unit 110. The design master 113 includes items of a design ID, a design name, a design pattern file, the body type lower limit, and the body type upper limit.

The design ID is registered in the item of the design ID. A name of the design is registered in the item of the design name. A name of the design pattern file for identifying the design is registered in the item of the design pattern file. The design pattern file is a file used for identifying the design ID by a collation with a pattern included in a predetermined region in the captured image. A value indicating a lower limit of the body type having the high affinity with respect to the relevant design is registered in the item of the body type lower limit. A value indicating an upper limit of the body type having the high affinity with respect to the relevant design is registered in the item of the body type upper limit.

For example, a record indicating that the design ID is “p1”, the design name is “stripes”, the design pattern file is “pattern1”, the body type lower limit is “3”, and the body type upper limit is “5” is registered in the design master 113. This record indicates that a design name having the design ID “p1” is “stripes (narrow width)”. In addition, it is indicated that a file name of the design pattern file representing the design “stripes (narrow width)” is “pattern1”. Furthermore, it is indicated that this design has the high affinity with respect to individuals having the body type categories “3” to “5”.

Herein, the affinity with respect to the body type can also be considered with regard to designs similarly as in colors. For example, it is considered that narrow width stripes have the high affinity with respect to a relatively heavy person (because the wearing person looks thinner on it). For example, the range of the body type category having the high affinity with respect to a certain color is previously registered in the design master 113 based on the above-mentioned concept. It is noted that a design having the high affinity with respect to all the body type categories also exists.

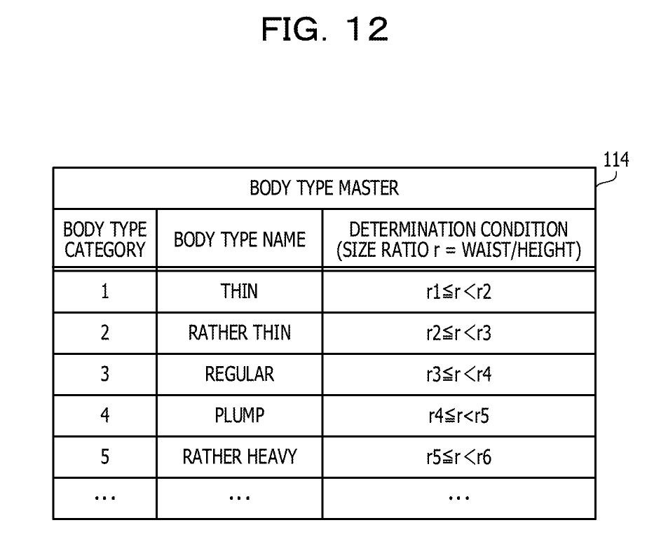

FIG. 12 illustrates an example of the body type master according to the third exemplary embodiment. A body type master 114 is stored in the master storage unit 110. The body type master 114 includes items of the body type category, a body type name, and a determination condition.

The body type category is registered in the item of the body type category. A name of the body type corresponding to the body type category is registered in the item of the body type name. A determination condition for the body type is registered in the item of the determination condition. According to the third exemplary embodiment, a size ratio r of the waist to the height (=waist size/height) is considered as an example of the determination condition for the body type.

For example, a record indicating that the body type category is “1”, the body type name is “thin”, and the determination condition is “r1≤r<T2” is registered. This indicates that the body type name of the body type category “1” is “thin”. It is also indicated that, in a case where the size ratio r of a certain person is higher than or equal to r1 and lower than or equal to r2, this person is classified into “thin”.

It is noted that the determination condition based on the size ratio r of the waist to the height has been illustrated as an example of the determination condition for the body type, but the body type may be determined based on other determination conditions.

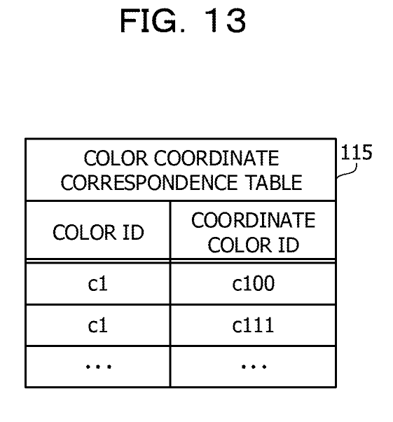

FIG. 13 illustrates an example of the color coordinate correspondence table according to the third exemplary embodiment. A color coordinate correspondence table 115 is stored in the master storage unit 110. The color coordinate correspondence table 115 includes items of a color ID and a coordinate color ID.

The color ID is registered in the item of the color ID. The color ID having the high affinity with respect to the color having the color ID registered in the item of the color ID (which is referred to as a high affinity color or alternatively which may be mentioned as a harmonizing color) is registered in the item of the coordinate color ID.

For example, a record indicating that the color ID is “c1” and the coordinate color ID is “c100” is registered in the color coordinate correspondence table 115. This record indicates that a color having the color ID “c1” has the high affinity with respect to a color having the color ID “c100”.

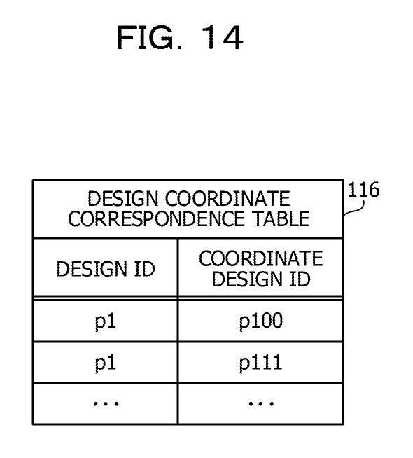

FIG. 14 illustrates an example of the design coordinate correspondence table according to the third exemplary embodiment. The design coordinate correspondence table 116 is stored in the master storage unit 110. The design coordinate correspondence table 116 includes items of the design ID and a coordinate design ID.

The design ID is registered in the item of the design ID. The design ID of the design having the high affinity with respect to the design having the design ID registered in the item of the design ID (which is referred to as a high affinity design or alternatively which may also be referred to as a harmonizing design) is registered in the item of the coordinate design ID.

For example, a record indicating that the design ID is “p1” and the coordinate design ID is “p100” is registered in the design coordinate correspondence table 116. This record indicates that a design having the design ID “p1” has the high affinity with respect to a design having the design ID “p100”.

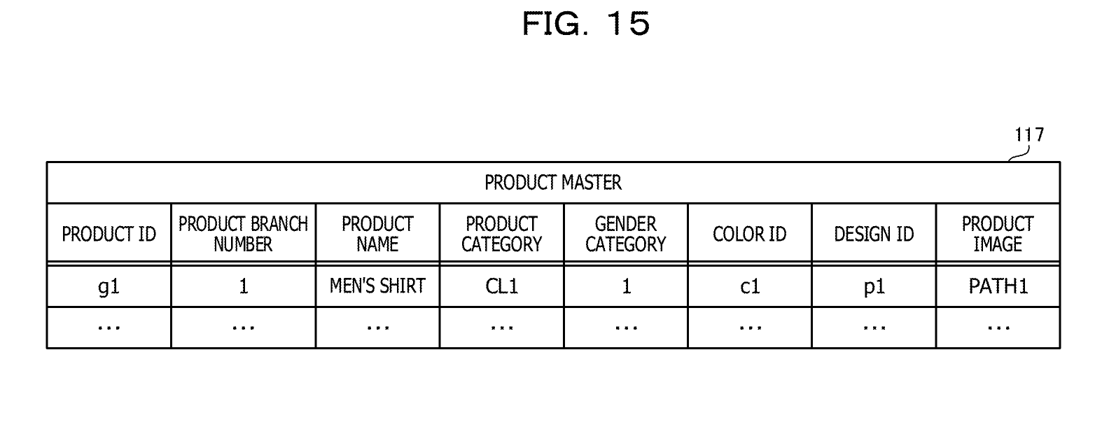

FIG. 15 illustrates an example of the product master according to the third exemplary embodiment. The product master 117 is stored in the master storage unit 110. The product master 117 includes items of the product ID, a product branch name, a product name, the product category, a gender category, the color ID, the design ID, and a product image.

The product ID is registered in the item of the product ID. The product branch name is registered in the item of the product branch name. The product branch name is, for example, information used for distinguishing colors or designs with respect to the product. A name of the product is registered in the item of the product name. The product category is registered in the item of the product category. The category in accordance with the wearing regions of the product is previously determined such as outerwear, tops, and bottoms. The gender category is registered in the item of the gender category. As will be described below, the gender category “0” indicates no specification of male and female, the gender category “1” indicates male, and the gender category “2” indicates female. The color ID is registered in the item of the color ID. The design ID is registered in the item of the design ID. A path representing a storage destination of a file of the product image or the product image is registered in the item of the product image.

For example, a record indicating that the product ID is “g1”, the product branch name is “1”, the product name is “men's shirt”, the product category is “CL1”, the gender category is “1”, the color ID is “c1”, the design ID is “p1”, and the product image is “PATH1” is registered in the product master 117. This record indicates a product name of the product corresponding to that the product ID “g1” and the product the branch number “1” is “men's shirt”. It is also indicated that, with regard to this product, the product category is “CL1” and is targeted for men, and the product in which the color having the color ID “c1” and the design having the design ID “p1” is prepared. Furthermore, it is indicated that the product image of the product is a file indicated by “PATH1”.

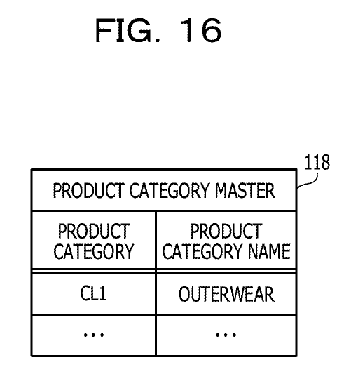

FIG. 16 illustrates an example of the product category master according to the third exemplary embodiment. The product category master 118 is stored in the master storage unit 110. The product category master 118 includes items of the product category, and a product category name.

The product category is registered in the item of the product category. A name of the product category is registered in the item of the product category name.

For example, a record indicating that the product category is “CL1” and the product category name is “outerwear” is registered in the product category master 118. This record indicates that the product category name corresponding to the product category “CL1” is “outerwear”.

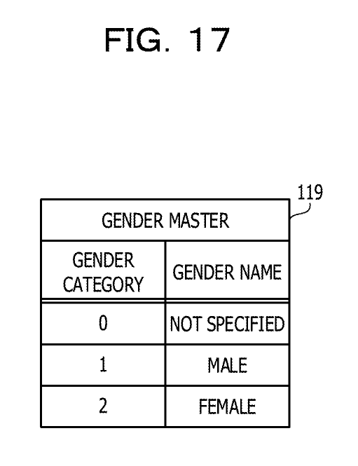

FIG. 17 illustrates an example of the gender master according to the third exemplary embodiment. The gender master 119 is stored in the master storage unit 110. The gender master 119 includes items of the gender category and a gender name.

The gender category is registered in the item of the gender category. A gender name corresponding to the gender category is registered in the item of the gender name.

For example, a record indicating that the gender category is “0” and the gender name is “not specified” is registered in the gender master 119. This record indicates that the gender name the corresponding to the gender category “0” is “not specified”.

Next, examples of screen transition display on the display 105a in the terminal apparatus 100 will be described. The browser 120 may obtain information of the display screen from the web server 220 to be saved in the RAM 102 or the flash memory 103. The information of the display screen may also be previously saved in the flash memory 103.

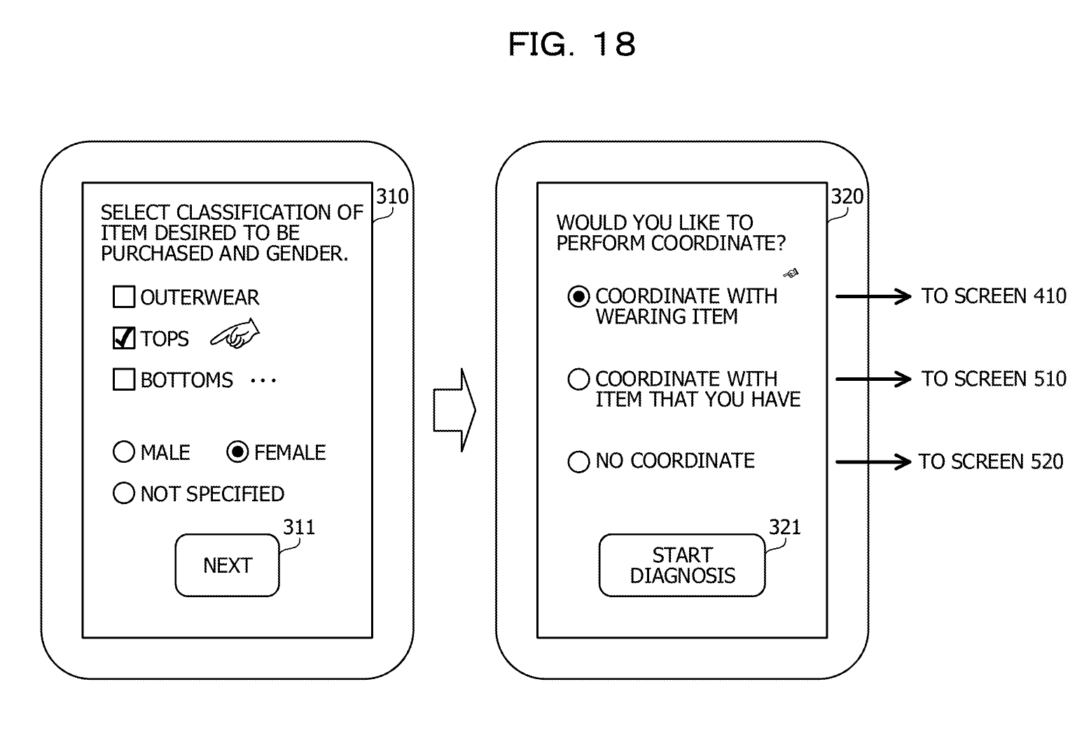

FIG. 18 illustrates an example of the screen transition according to the third exemplary embodiment (part 1). A screen 310 is displayed by the display 105a when the browser 120 is activated. The screen 310 is a GUI for accepting a classification of an item (product) desired by the customer to purchase and a selection of the gender of the customer. Herein, the item classification is equivalent to the product category. For example, the screen 310 includes check boxes for selecting the item classification, radio buttons for selecting the gender (male, female, or not specified), and the like. When the user presses a button 311 (for example, by accepting a tap operation with respect to the button 311), the browser 120 confirms the selection contents on the screen 310 and displays a screen 320 on the display 105a.

The screen 320 is a GUI for accepting a selection on whether or not the customer desires to accept coordinate support, and in a case where the coordinate support is accepted, whether the coordinate is performed with the wearing item or the item that is not put on. For example, the screen 320 includes display of three items of “coordinate with wearing item”, “coordinate with item that you have”, and “no coordinate” and radio buttons corresponding to the respective items. When the user presses a button 321, the browser 120 confirms the selected contents on the screen 320. Subsequently, the browser 120 notifies the item search unit 130 of the items selected on the screens 310 and 320 and requests for the item search.

The item search unit 130 determines a screen to be displayed on the display 105a in accordance with the items selected on the screen 320.

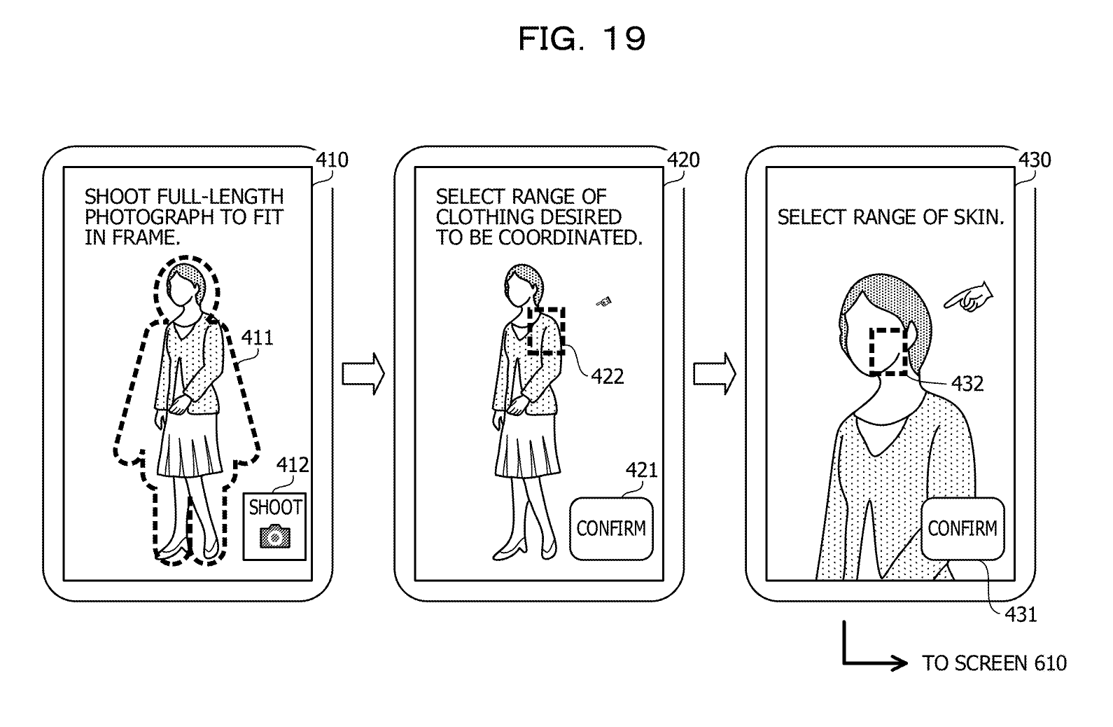

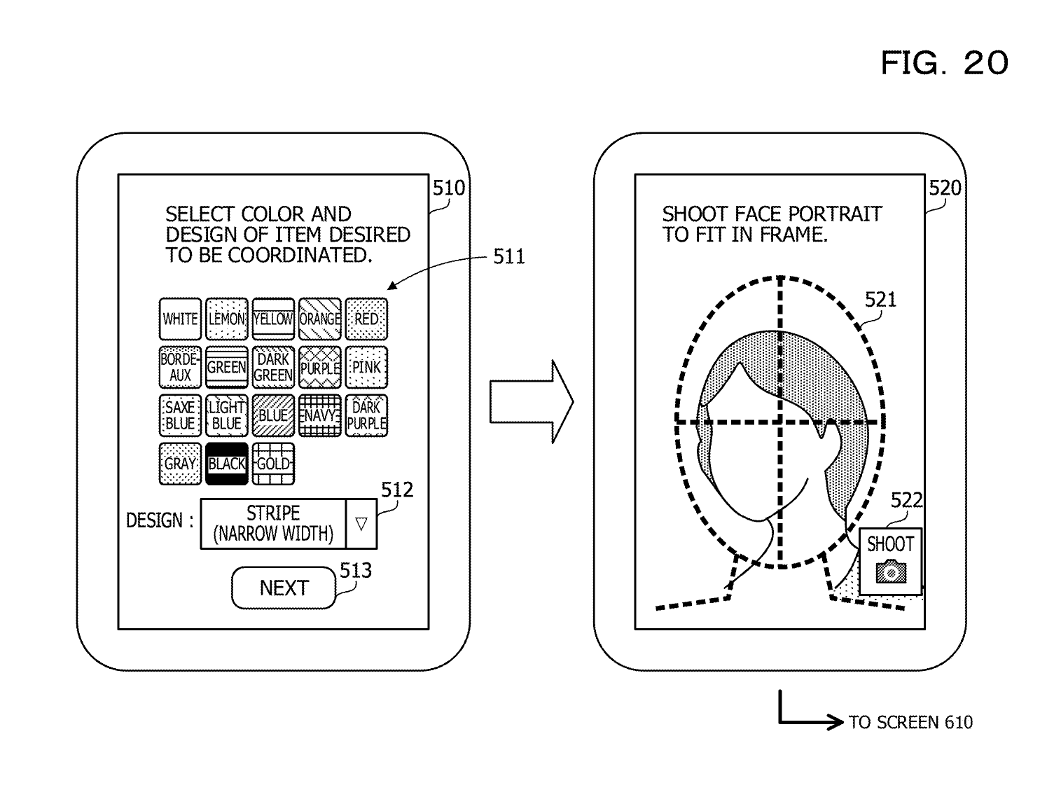

In a case where “coordinate with wearing item” is selected, the item search unit 130 activates the camera 104 and displays a screen 410 (FIG. 19). In a case where “coordinate with item that you have” is selected, the item search unit 130 displays a screen 510 (FIG. 20). In a case where “no coordinate” is selected, the item search unit 130 displays a screen 520 (FIG. 20).

FIG. 19 illustrates an example of the screen transition according to the third exemplary embodiment (part 2). The screen 410 is a GUI for supporting shooting of a full-length photograph of the customer (full-length image) by the user. The screen 410 includes an image captured by the camera 104. In addition, the screen 410 includes a message “shoot full-length photograph to fit in frame.” which is superimposed on the image, a human shaped frame 411 and a button 412. The button 412 is a button for causing the terminal apparatus 100 to obtain the image of the customer included in the screen 410 as a still image. The user (for example, the shop assistant) can fit the full-length image of the customer in the frame 411 by adjusting the orientation of the terminal apparatus 100, the distance to the customer, the zoom of the camera 104, and the like. When the button 412 is pressed, the item search unit 130 saves the current full-length image captured by the screen 410 in a predetermined storage area of the RAM 102 or the flash memory 103 and stops the camera 104. Then, the item search unit 130 causes the display 105a to display a screen 420.

The screen 420 is a GUI for accepting a selection of a range of clothing desired to be coordinated by the user. The screen 420 includes the full-length image of the customer captured by using the screen 410, a message “select range of clothing desired to be coordinated”, a button 421, and a selection frame 422. For example, the customer changes a size of the selection frame 422 by a pinch-in operation or a pinch-out operation or moves the selection frame 422 by a drag operation, so that it is possible to select a range (region) of the clothing desired to be coordinated by itself in the full-length image. When the button 421 is pressed, the item search unit 130 confirms the selection based on the selection frame 422 and extracts information of a color and a design included in the region selected by the selection frame 422. Then, the item search unit 130 causes the display 105a to display a screen 430.

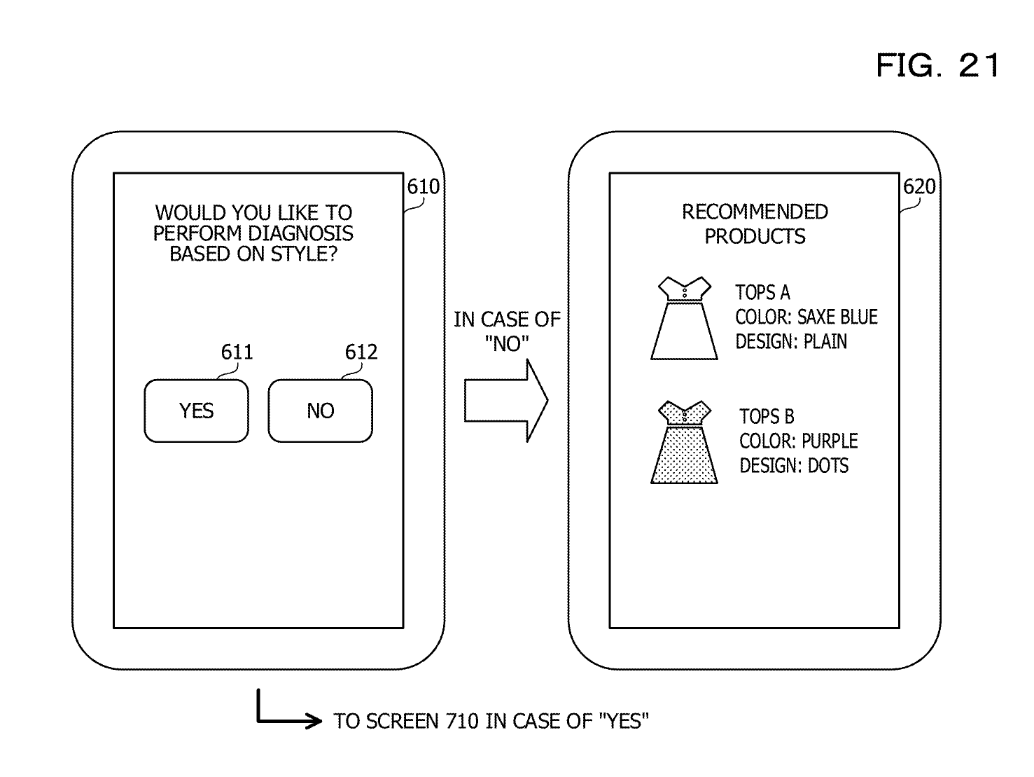

The screen 430 is a GUI for accepting a selection of a range of the skin by the user. The screen 420 includes the full-length image of the customer captured by using the screen 410 (or an image obtained by expanding a face part in the full-length image), a message “select range of skin.”, a button 431, and a selection frame 432. For example, the customer can change a size of the selection frame 432 by the pinch-in operation or the pinch-out operation or move the selection frame 432 by the drag operation. When the button 431 is pressed, the item search unit 130 confirms the selection based on the selection frame 432 and extracts information of a color and a design included in the region selected by the selection frame 432. Then, the item search unit 130 causes the display 105a to display a screen 610 (FIG. 21).

FIG. 20 illustrates an example of the screen transition according to the third exemplary embodiment (part 3). The screen 510 is a GUI for accepting a selection of a color and a design of the item desired to be coordinated (item of the coordinate target) by the customer. The screen 510 includes a color selection button group 511, a design selection form 512, and a button 513. The color selection button group 511 is a group of buttons for accepting a selection of a color of an item desired to be coordinated. The color selection button group 511 may also be a GUI called “color palette”. The buttons belonging to the color selection button group 511 are assigned with names of colors corresponding to the buttons, for example, and also displayed while being colored in the relevant colors. With regard to an example of the screen 510, an example is illustrated in which the buttons of a plurality of colors such as white, lemon, yellow, orange, red, . . . , are displayed. The user presses one of the buttons in the color selection button group 511, so that it is possible to select the color of the item desired to be coordinated.

The design selection form 512 is a drop-down list for accepting a selection of the design (alternatively, a pull-down list). It is noted that the design selection form 512 also includes an option where narrowing-down based on the design is not performed (no design selection).

When the button 513 is pressed, the item search unit 130 confirms the color selected by the color selection button group 511 and the design selected by the design selection form 512 and activates the camera 104. Then, the item search unit 130 causes the display 105a to display the screen 520.

The screen 520 is a GUI for supporting shooting of a face portrait (face image) of the customer by the user. The screen 520 includes the image captured by the camera 104. In addition, the screen 520 includes a message “shoot face portrait to fit in frame.” which is superimposed on the image, a face shaped frame 521, and a button 522. The button 522 is a button for causing the terminal apparatus 100 to obtain the image of the customer included in the screen 520 as a still image. The user (for example, the shop assistant) can fit the face image of the customer in the frame 521 by adjusting the orientation of the terminal apparatus 100, the distance to the customer, the zoom of the camera 104, and the like. When the button 522 is pressed, the item search unit 130 saves the current face image captured by the camera 104 in the predetermined storage area of the RAM 102 or the flash memory 103 and stops the camera 104. The item search unit 130 detects a region of the skin of the customer from the face image and extracts a color of the region. Then, the item search unit 130 causes the display 105a to display the screen 610 (FIG. 21).

FIG. 21 illustrates an example of the screen transition according to the third exemplary embodiment (part 4). The screen 610 is a GUI for accepting a selection on whether or not a diagnosis based on a style of the customer is performed. Herein, the “diagnosis based on the style” indicates that a proposal of the product more suited to the customer is performed by narrowing down the items in accordance with the body type of the customer. The screen 610 includes a message “would you like to perform diagnosis based on style?”. In addition, the screen 610 includes buttons 611 and 612. The button 611 is a button for accepting an input indicating the “diagnosis based on style is performed”. The button 612 is a button for accepting an input indicating the “diagnosis based on style is not performed”.

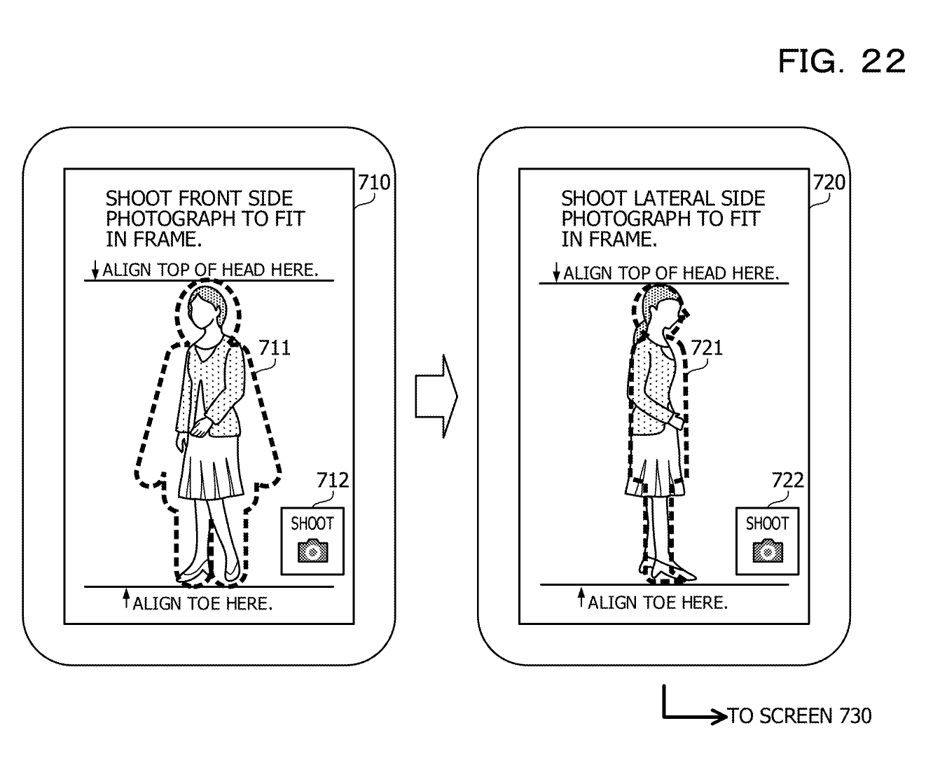

When the button 611 is pressed, the item search unit 130 requests the body type determination unit 140 to perform the body type determination. When the request of the body type determination is accepted, the body type determination unit 140 activates the camera 104 and causes the display 105a to display a screen 710 (FIG. 22).

When the button 612 is pressed, the item search unit 130 searches the product master 117 for the product ID of the product having the high affinity color with respect to the customer in accordance with the personal color or the color of the item of the coordinate target and provides the search result to the browser 120.

The browser 120 obtains information of the product ID searched for by the item search unit 130 from the product master 117 and causes the display 105a to display a screen 620 including the obtained information. For example, the screen 620 includes product names such as “tops A” and “tops B” as “recommended products” with respect to the customer, color images of the relevant products, color names, design names, and the like. For example, the browser 120 may accept an input of a product of a purchase target by the customer by accepting a touch operation with respect to the product name or the product color image. In this case, it is also conceivable that the browser 120 further presents a stock check result of the relevant product (product selected by the customer) or a GUI for purchasing the product in collaboration with the web server 220 to the customer.

FIG. 22 illustrates an example of the screen transition according to the third exemplary embodiment (part 5). The screen 710 is a GUI for supporting shooting of a full-size front side photograph (front side image) of the customer by the user. The screen 710 includes the image captured by the camera 104. In addition, the screen 710 includes a message “shoot front side image to fit in frame.” which is superimposed on the image, a human shaped frame 711 as viewed from the front side and a button 712. Furthermore, the screen 710 includes a first line segment that is in contact with an end part on a top of head side of the frame 711 and extends in a screen crosswise direction and a second line segment that is in contact with an end part on a toe side of the frame 711 and extends in the screen crosswise direction. For example, a message “align top of head here.” is added on an upper side of the first line segment. A message a message “align toe here.” is added on a lower side of the second line segment.

The button 712 is a button for causing the terminal apparatus 100 to obtain the image of the customer included in the screen 710 as a still image. The user (for example, the shop assistant) can fit the front side image of the customer in the frame 711 by adjusting the orientation of the terminal apparatus 100, the distance to the customer, the zoom of the camera 104, and the like. When the button 712 is pressed, the body type determination unit 140 saves the current front side image captured by the camera 104 in the predetermined storage area of the RAM 102 or the flash memory 103. Subsequently, the body type determination unit 140 causes the display 105a to display a screen 720.

The screen 720 is a GUI for supporting shooting of a full-size lateral side photograph (lateral side image) of the customer by the user. The screen 720 includes the image captured by the camera 104. In addition, the screen 720 includes a message “shoot lateral side photograph to fit in frame.” which is superimposed on the image, a human shaped frame 721 as viewed from the lateral side and a button 722. Furthermore, the screen 720 includes a third line segment that is in contact with an end part on a top of head side of the frame 721 and extends in the screen crosswise direction and a fourth line segment that is in contact with an end part on a toe side of the frame 721 and extends in the screen crosswise direction. For example, a message “align top of head here.” is added on an upper side of the third line segment. A message “align toe here.” is added on a lower side of the fourth line segment.

It is noted that a length on the screen 710 between the first line segment and the second line segment is the same as a length on the screen 720 between the third line segment and the fourth line segment.

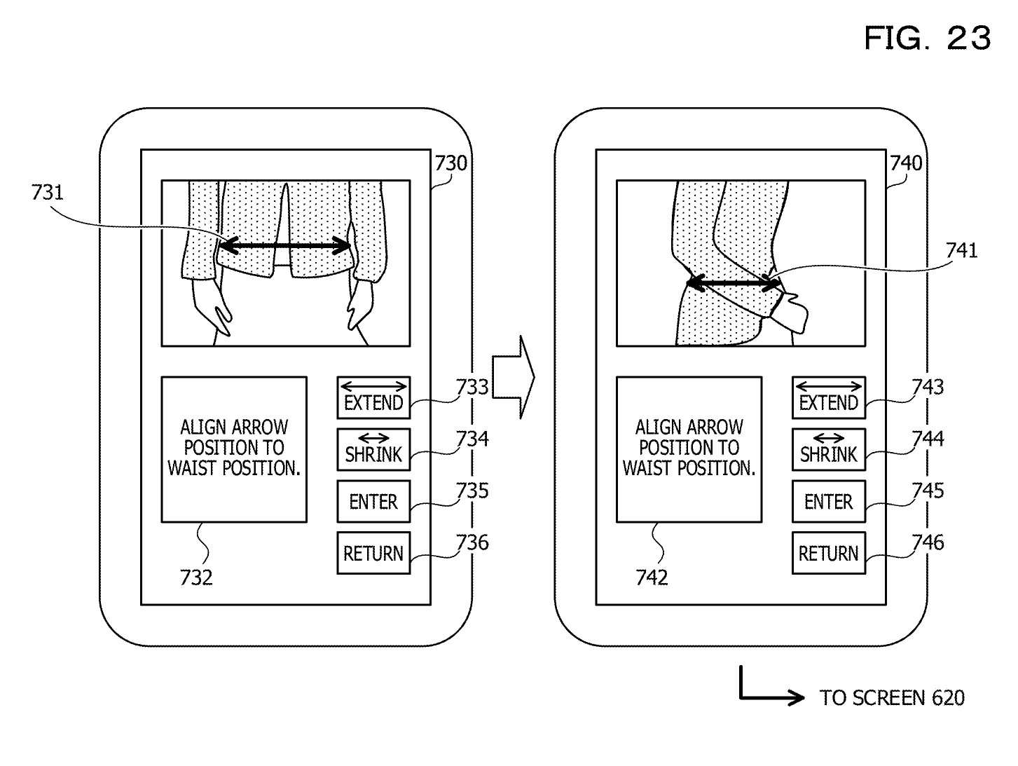

The button 722 is a button for causing the terminal apparatus 100 to obtain the image of the customer included in the screen 720 as a still image. The user (for example, the shop assistant) can fit the lateral side image of the customer in the frame 721 by adjusting the orientation of the terminal apparatus 100, the distance to the customer, the zoom of the camera 104, and the like. When the button 722 is pressed, the body type determination unit 140 saves the current lateral side image captured by the camera 104 in the predetermined storage area of the RAM 102 or the flash memory 103 and stops the camera 104. Subsequently, the body type determination unit 140 causes the display 105a to display a screen 730 (FIG. 23).

FIG. 23 illustrates an example of the screen transition according to the third exemplary embodiment (part 6). The screen 730 is a GUI for accepting an adjustment of a length related to a specific region for determining the body type of the customer. Herein, a case is illustrated where the waist is used as an example of the specific region. The screen 730 includes an expanded image of a part equivalent to the waist in the front side image obtained by using the screen 710. It is noted that the master storage unit 110 previously stores information of the waist position in the frame 711. The body type determination unit 140 identifies the part for the expansion of the front side image corresponding to the waist position by referring to the information of the waist position stored in the master storage unit 110.

In addition, the screen 730 includes an arrow object 731 overlapped on the expanded image. The arrow object 731 is an auxiliary line (line segment) for measurement and is provided with arrows on both ends. The arrow object 731 is displayed such that the arrow object can be moved to the left, right, top, and bottom on the screen 730. Movement and adjustment of a length of the arrow object 731 can be performed by predetermined touch operations by the user. Information of a default length and display position of the arrow object 731 is previously stored in the master storage unit 110 in accordance with the region.

Furthermore, the screen 730 includes a message display region 732 and buttons 733, 734, 735, and 736.

The message display region 732 includes display of an explanation sentence “align arrow position to waist position.”.

The button 733 is a button for accepting an operation input for extending the length of the arrow object 731. For example, each time the button 733 is pressed once (tapped once), the body type determination unit 140 increases the length of the arrow object 731 by a predetermined amount. Alternatively, each time the button 733 is pressed once, the body type determination unit 140 expands the arrow object 731 in a bilaterally-symmetric manner by a predetermined magnification.

The button 734 is a button for accepting an operation input for shrinking the length of the arrow object 731. For example, each time the button 734 is pressed once, the body type determination unit 140 decreases the length of the arrow object 731 by a predetermined amount. Alternatively, each time the button 734 is pressed once, the body type determination unit 140 reduces the arrow object 731 in a bilaterally-symmetric manner by a predetermined magnification.

The button 735 is a button for accepting a completion of the adjustment of the arrow object 731. When the touch operation with respect to the button 735 is accepted, the body type determination unit 140 obtains the adjustment amounts of the length and the position with respect to the arrow object 731 (adjustment amounts with respect to the default length and position).

The button 736 is a button for accepting an operation input for returning to the previous screen.

Herein, as described above, the length and the position of the arrow object 731 can be adjusted by the user. For example, when the user slides the arrow object 731 while being touched by one finger, the position of the arrow object 731 can be aligned to the waist position of the expanded image with regard to the front side image. In addition, the user can increase the length of the arrow object 731 by performing the pinch-out operation while touching the vicinity of the arrow object 731 by two fingers. The user can also decrease the length of the arrow object 731 by performing the pinch-in operation while touching the vicinity of the arrow object 731 by two fingers. In this manner, the user can align both ends of the arrow object 731 to edges of a waist contour of the person in the expanded image.

When the button 735 is pressed, the body type determination unit 140 causes the display 105a to display a screen 740.

The screen 740 is a GUI for accepting an adjustment of the length with regard to the specific region used in the determination of the body type of the customer similarly as in the screen 730. The screen 740 is different from the screen 730 in that the adjustment is accepted based on the lateral side image obtained by using the screen 720.

The screen 740 includes an expanded image of a part equivalent to the waist in the lateral side image obtained by using the screen 720. It is noted that the master storage unit 110 previously stores the information of the waist position in the frame 721. The body type determination unit 140 identifies the part for the expansion of the lateral side image corresponding to the waist position by referring to the information of the waist position stored in the master storage unit 110.

In addition, the screen 740 includes an arrow object 741 overlapped on the expanded image. Information of a default length and display position of the arrow object 741 is previously stored in the master storage unit 110 in accordance with the region. The user can adjust the position and the length of the arrow object 741 similarly as in the arrow object 731. The user can align both ends of the arrow object 741 to the edges of the waist contour of the person in the expanded image.

Furthermore, the screen 740 includes a message display region 742 and buttons 743, 744, 745, and 746.

The message display region 742 includes display of an explanation sentence “align arrow position to waist position.”.

The buttons 743 and 744 are buttons for accepting an adjustment of the length of the arrow object 741 similarly as in the buttons 733 and 734.

The button 745 is a button for accepting a completion of the adjustment of the arrow object 741. When the touch operation with respect to the button 745 is accepted, the body type determination unit 140 obtains the adjustment amounts of the length and the position with respect to the arrow object 741 (adjustment amounts with respect to the default length and position).

The button 746 is a button for accepting an operation input for returning to the previous screen.

When the button 745 is pressed, the body type determination unit 140 obtains the size ratio r=waist/height based on the adjustment amounts of the arrow objects 731 and 741 obtained by using the screens 730 and 740. The body type determination unit 140 refers to the body type master 114 and determines the body type category of the customer in accordance with the size ratio r to provide the body type category to the item search unit 130.

The body type determination unit 140 determines the body type category based on the predetermined determination condition in accordance with the size ratio r as described above. The body type determination unit 140 can obtain the size ratio r as follows.

First, the body type determination unit 140 sets a length on the screen between a first straight line and a second straight line on the screen 710 (or a length on the screen between a third straight line and a fourth straight line on the screen 720) as h0. It can be mentioned that the length h0 is a length corresponding to a height of the customer. The body type determination unit 140 obtains a length h1=u/α calculated by dividing a length u after the adjustment of the arrow object 731 on the screen 730 by an expansion rate a of the expanded image on the screen 730 (expansion rate with respect to the screen 710). Furthermore, the body type determination unit 140 obtains a length h2=v/β calculated by dividing a length v after the adjustment of the arrow object 741 on the screen 740 by an expansion rate β of the expanded image on the screen 740 (expansion rate with respect to the screen 720).

In this case, the body type determination unit 140 obtains a circumference of an ellipse having a major axis (length of a long axis) h1 and a minor axis (length of a short axis) h2 while a length corresponding to the waist is set as w.

Subsequently, the body type determination unit 140 obtains the size ratio r by calculating r=w/h0.

The item search unit 130 refers to the product master 117 and narrows down the product IDs of the products presented to the customer based on the body type category determined by the body type determination unit 140. The item search unit 130 provides the narrowed-down product IDs to the browser 120.

The browser 120 obtains the information of the product ID obtained from the item search unit 130 from the product master 117 and causes the display 105a to display the screen 620 including the obtained information.

Next, a processing procedure by the terminal apparatus 100 will be described.

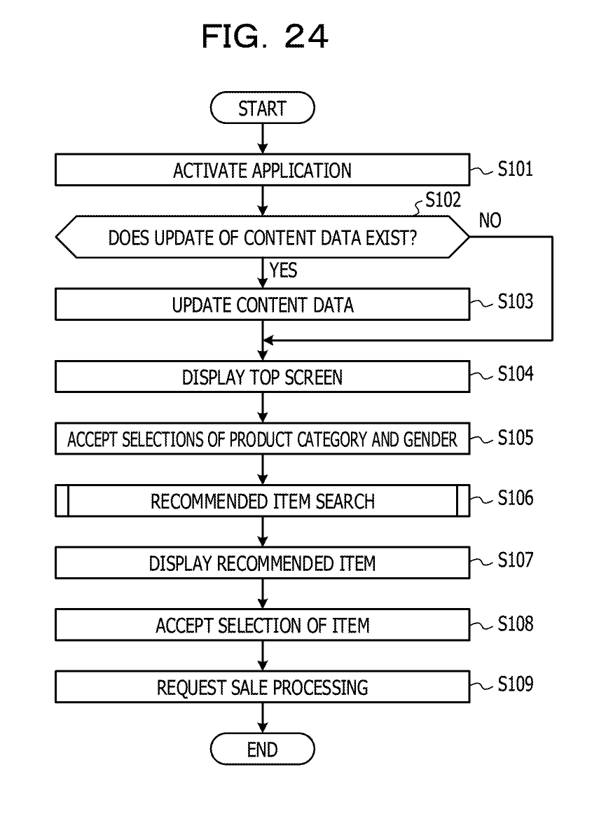

FIG. 24 is a flow chart illustrating a processing example of the terminal apparatus according to the third exemplary embodiment. Hereinafter, the processing illustrated in FIG. 24 will be described along step numbers.

(S101) The terminal apparatus 100 activates the browser 120, the item search unit 130, and the body type determination unit 140 (application activation).

(S102) The browser 120 determines whether or not update of content data exists. In a case where the update of the content data exists, the browser 120 proceeds to the processing in step S103. In a case where the update of the content data does not exist, the browser 120 proceeds to the processing in step S104. Herein, the content data is data equivalent to the above-mentioned master information. For example, the browser 120 inquires the server 200 on whether the master information of a newer version than the version assigned to the master information stored in the master storage unit 110. Subsequently, when a reply indicating that the master information of the new version exists is accepted from the server 200, the browser 120 determines that the content data has update. When a reply indicating that the master information of the new version does not exist is accepted from the server 200, the browser 120 determines that the content data has no update.

(S103) The browser 120 downloads the content data of the latest version from the server 200 and updates the content data stored in the master storage unit 110.

(S104) The browser 120 causes the display 105a to display a top screen (the screen 310).

(S105) The browser 120 accepts selections of the product category (equivalent to the item classification) and the gender with respect to the screen 310.

(S106) The browser 120 causes the display 105a to display the screen 320 and accepts the selection by the user. The browser 120 notifies the item search unit 130 of information of the product category and gender selected in step S105 and the item selected on the screen 320 and requests the recommended item searching. The browser 120 obtains the searched recommended item from the item search unit 130. A detail of the recommended item search processing will be described below.

(S107) The browser 120 causes the display 105a to display the information of the recommended item and the screen 620 including the color image.

(S108) The browser 120 accepts a selection by the user with respect to any item among the recommended items displayed on the screen 620.

(S109) The browser 120 requests the server 200 to perform stock check processing and sale processing of the selected item. When a reply indicating that the sale processing is completed is accepted from the server 200, the browser 120 causes the display 105a to display a message indicating that the sale processing is appropriately completed. In a case where an identity verification, an input of payment information, and the like are performed along with the sale processing, the browser 120 can also cause the display 105a to display a GUI for the purpose.

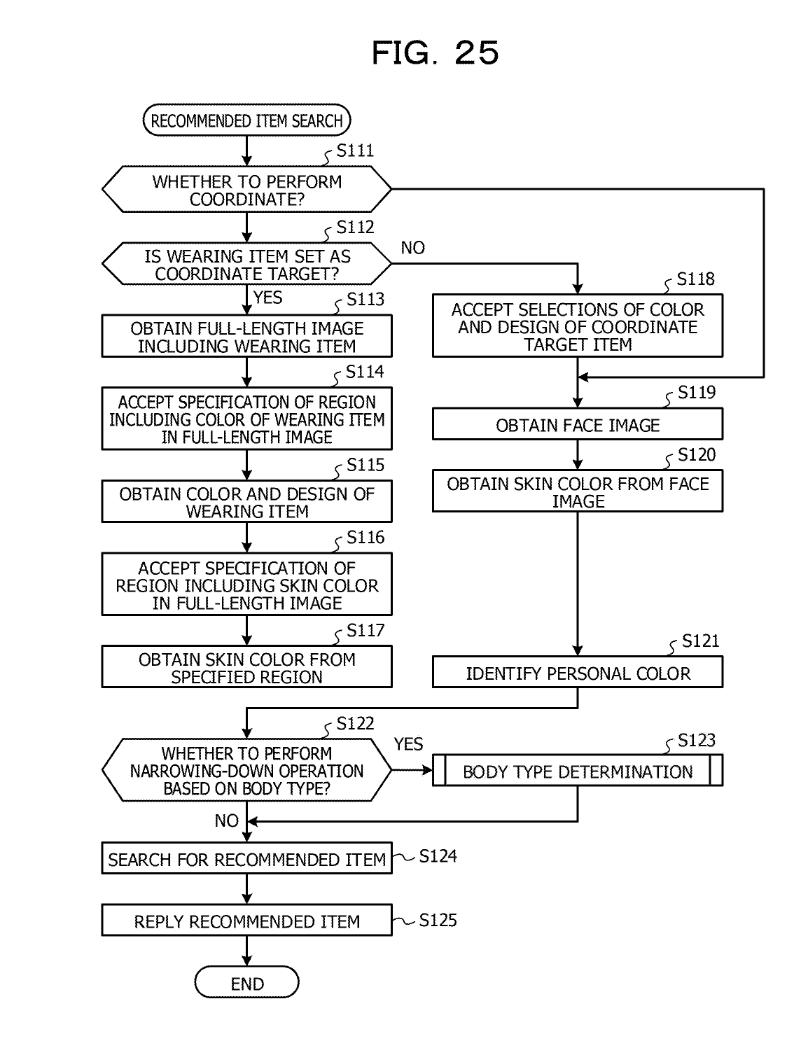

FIG. 25 is a flow chart illustrating a recommended item search example according to the third exemplary embodiment. Hereinafter, the processing illustrated in FIG. 25 will be described along step numbers. The following procedure is equivalent to step S106 of FIG. 24.

(S111) The item search unit 130 determines whether or not a selection indicating that the coordinate is performed is made on the screen 320. In a case where the coordinate is performed, the item search unit 130 proceeds to the processing in step S112. In a case where the coordinate is not performed, the item search unit 130 proceeds to the processing in step S119. The “case where the coordinate is performed” refers to a case where an item other than the item “no coordinate” is selected on the screen 320. The “case where the coordinate is not performed” refers to a case where the item “no coordinate” is selected on the screen 320.

(S112) The item search unit 130 determines whether or not a selection indicating that the wearing item is set as the coordinate target is made on the screen 320. In a case where the wearing item is set as the coordinate target, the item search unit 130 proceeds to the processing in step S113. In a case where the wearing item is not set as the coordinate target, the item search unit 130 proceeds to the processing in step S118. The “case where the wearing item is set as the coordinate target” refers to a case where the item “coordinate with wearing item” is selected on the screen 320. The “case where the wearing item is not set as the coordinate target” refers to a case where the item “coordinate with item that you have” is selected on the screen 320.

(S113) The item search unit 130 obtains the full-length image of the customer including the wearing item. Specifically, the item search unit 130 causes the display 105a to display the screen 410 and supports shooting of the full-length image of the customer by the user (for example, the shop assistant). Subsequently, when the button 412 of the screen 410 is pressed, the item search unit 130 obtains the full-length image of the customer captured by the camera 104.

(S114) The item search unit 130 accepts a specification of a region including a color of the wearing item in the full-length image. Specifically, the item search unit 130 causes the display 105a to display the screen 420 and accepts a selection of a region including a color and a design of the wearing item by the user (for example, the shop assistant or the customer).

(S115) The item search unit 130 analyses the region specified in step S114 and obtains the color and the design included in the region. For example, the master storage unit 110 previously holds a correspondence information for each color between a combination of the range of the color value, the range of the brightness, and the range of the saturation which a pixel has (which may also be a combination of other parameters such as the range of the hue, the range of the color value, and the range of the saturation) and the color. The item search unit 130 associates the respective pixels included in the relevant region with the colors based on the correspondence information stored in the master storage unit 110. The relevant region includes pixels corresponding to the plurality of colors, the item search unit 130 extracts a color that the highest number of pixels are classified to have (color having a highest abundance ratio in this region) as a color of the region. The item search unit 130 obtains a color ID of a color close to the extracted color (color having the most approximate set of parameters of the color value, the brightness, and the saturation) from the color master 112. The color ID obtained herein is equivalent to the coordinate color ID in the color coordinate correspondence table 115.

Furthermore, the item search unit 130 obtains pattern information representing patterns of color changes in respective pixels included in the relevant region. The pattern information has a feature in accordance with the design. The item search unit 130 collates the design pattern files of the respective designs of the design master stored in the master storage unit 110 with the pattern information extracted from the relevant region to obtain the design ID corresponding to the relevant region from the design master 113. The design ID obtained herein is equivalent to the coordinate design ID in the design coordinate correspondence table 116.

(S116) The item search unit 130 accepts a specification of a region including the skin color in the full-length image. Specifically, the item search unit 130 causes the display 105a to display the screen 430 and accepts the selection of the region including the skin color by the user (for example, the shop assistant or the customer). The item search unit 130 may identify a part equivalent to the face of the customer in the full-length image by using the facial recognition technology and expand the part to be displayed on the screen 430. This is because the face has a human skin more exposed than the other regions in many cases, and it is easy to specify the region including the skin color.

(S117) The item search unit 130 analyses the region specified in step S116 and obtains the skin color of the customer included in the region. For example, the master storage unit 110 may previously hold correspondence information between a combination of the range of the color value, the range of the brightness, and the range of the saturation which is equivalent to the skin color (which may also be a combination of other parameters such as the range of the hue, the range of the color value, and the range of the saturation) and the color equivalent to the skin color for each type of skin colors. Then, the item search unit 130 can associate each pixel included in the relevant region with one type of skin colors based on the correspondence information of the skin color which is stored in the master storage unit 110 similarly as in step S115 to be extracted the skin color of the customer. In a case where the relevant region includes pixels corresponding to the plural types of the skin colors, the item search unit 130 extracts a skin color of a type that the highest number of pixels are classified to have as the skin color of the customer.

Alternatively, for example, the item search unit 130 may obtain a combination of the color value, the brightness, and the saturation (which may be a combination of other parameters such as the hue, the color value, and the saturation) equivalent to the skin color of the customer by using the method mentioned in Japanese Laid-open Patent Publication No. 2015-184906. Specifically, the item search unit 130 detects a set of pixels having a range of the colors equivalent to the skin color in the specified region as a skin color region and narrows the range of the colors until a difference between an evaluation value representing a size of the skin color region and a predetermined reference size is no longer included in a predetermined allowable range. Subsequently, the item search unit 130 extracts the narrowest color range (alternatively, one color belonging to the range of the colors (for example, a color equivalent to median values of the respective parameter ranges of the color)) among the range of the colors where the difference is included in the predetermined allowable range as the skin color of the customer. Subsequently, the item search unit 130 proceeds to the processing in step S121.

(S118) The item search unit 130 accepts selections of a color and a design of the coordinate target item. Specifically, the item search unit 130 causes the display 105a to display the screen 510 and accepts the selections of the color and the design of the coordinate target item by the user (for example, the shop assistant or the customer). The item search unit 130 obtains the color ID (equivalent to the coordinate color ID) corresponding to the selected color and the design ID (equivalent to the coordinate design ID) corresponding to the selected design. It is noted that other methods may also be used as the selection method for the color and the design of the coordinate target item. For example, the item search unit 130 may cause the display 105a to display a plurality of sample images, and the user may select a sample image including a color and a design close to the coordinate target item from the plurality of sample images other than the selection form the color palette.

(S119) The item search unit 130 obtains the face image of the customer. Specifically, the item search unit 130 causes the display 105a to display the screen 520 and supports shooting of the face image of the customer by the user (for example, the shop assistant). Subsequently, when the button 522 of the screen 520 is pressed, the item search unit 130 obtains the face image of the customer captured by the camera 104.

(S120) The item search unit 130 analyses the face image obtained in step S119 and obtains the skin color of the customer from the face image. The item search unit 130 may accept a specification of a region equivalent to the skin by the user and extract the skin color as exemplified in steps S116 and S117. Alternatively, the item search unit 130 may extract the skin color by using a method mentioned in Japanese Laid-open Patent Publication No. 2015-184906 which is exemplified in step S117.

(S121) The item search unit 130 identifies a plurality of personal colors corresponding to the skin color obtained in step S117 or step S120. Specifically, the item search unit 130 refers to the personal color correspondence table 111 stored in the master storage unit 110 and identifies the season ID corresponding to the skin color obtained in step S117 or step S120. Subsequently, the item search unit 130 refers to the color master 112 stored in the master storage unit 110 and identifies the color ID (which may be plural in some cases) corresponding to the identified season ID as the personal color of the customer.

(S122) The item search unit 130 causes the display 105a to display the screen 610 and determines whether or not a narrowing-down operation based on the body type is performed in accordance with the selection on the screen 610 by the user. In a case where the narrowing-down operation based on the body type is performed, the item search unit 130 proceeds to the processing in step S123. In a case where the narrowing-down operation based on the body type is not performed, the item search unit 130 proceeds to the processing in step S124.

(S123) The item search unit 130 requests the body type determination unit 140 to determine the body type of the customer. The item search unit 130 obtains the determination result of the body type of the customer (body type category) from the body type determination unit 140. A detail of the body type determination processing will be described below.

(S124) The item search unit 130 searches for the recommended item (which may be plural in some cases) to be recommended to the customer among the products corresponding to the product category selected by the customer and the gender category based on the personal color identified by step S121. Some cases are considerable as the search method (which will be described below).

(S125) The item search unit 130 replies the searched recommended item (set of the product ID and the product branch name corresponding to the recommended item) to the browser 120.

Herein, the following cases are considerable as the search method for the recommended item in step S124.

A first case is a case of step S111-No and also step S122-No. In this case, the item search unit 130 refers to the product master 117 stored in the master storage unit 110 and searches for the product ID and the product branch name corresponding to the color ID (color ID of the personal color) obtained in step S121.

A second case is a case of step S111-No and also step S122-Yes. In this case, the item search unit 130 searches the color master 112 and the design master 113 stored in the master storage unit 110 for the color ID and the design ID corresponding to the body type category of the customer. For example, the color ID in which the body type category k of the customer is k1≤k≤k2 with respect to the body type lower limit k1 and the body type upper limit k2 in the color master 112 is the color ID corresponding to the body type category of the customer. The same also applies to the design ID. Subsequently, the item search unit 130 refers to the product master 117 and narrows down among the product IDs and the product branch names associated with the color ID and the design ID corresponding to the body type category of the customer among the product IDs and the product branch names searched for by the same method as the method in the first case. The item search unit 130 sets the results of the narrowing-down operation as the product ID and the product branch name of the recommended item. It is noted that, according to the present example, the narrowing-down operation is performed based on both the color ID and the design ID corresponding to the body type category of the customer, but the item search unit 130 may also perform the narrowing-down operation by using one of those.

A third case is a case of step S112-Yes and also step S122-No. In this case, the item search unit 130 refers to the color coordinate correspondence table 115 stored in the master storage unit 110 and searches for the color ID of the color having the high affinity with respect to the color having the color ID (the coordinate color ID) obtained in step S115. Herein, the searched color ID is set as a color ID “p”. In addition, the item search unit 130 refers to the design coordinate correspondence table 116 stored in the master storage unit 110 and searches for the design ID of the design having the high affinity with respect to the design having the design ID (the coordinate design ID) obtained in step S115. The design ID searched herein is set as a design ID “q”. Subsequently, the item search unit 130 refers to the product master 117 and narrows down the product IDs and the product branch names associated with the color IDs “p” and the design IDs “q” among the product IDs and the product branch names searched for by the same method as the method in the first case. The item search unit 130 sets the results of the narrowing-down operation as the product ID and the product branch name of the recommended item. It is noted that, according to the present example, the narrowing-down operation is performed based on both the color ID of the color of the coordinate target item and the design ID of the design of the coordinate target item, but the item search unit 130 may also perform the narrowing-down operation by using one of those.

A fourth case is a case of step S112-Yes and also step S122-Yes. The item search unit 130 further narrows down the color IDs “p” and the design IDs “q” based on the body type category of the customer. That is, the item search unit 130 refers to the color master 112 and searches for the color ID corresponding to the body type category of the customer among the color IDs equivalent to the color IDs “p”. In addition, the item search unit 130 refers to the design master 113 and searches for the design ID corresponding to the body type category of the customer among the design IDs equivalent to the design IDs “q”. Subsequently, the item search unit 130 narrows down the color IDs and the design IDs corresponding to the body type category of the customer among the product IDs and the product branch names searched for by the same method as the method in the third case. The item search unit 130 sets the results after the narrowing-down operation as the product ID and the product branch name of the recommended item. It is noted that, according to the present example, the narrowing-down operation is performed based on both the color ID and the design ID corresponding to the body type category of the customer, but the item search unit 130 may also perform the narrowing-down operation by using one of those.

A fifth case is a case of step S112-No and also step S122-No. In this case, the item search unit 130 searches for the recommended item similarly as in that method in the third case. It is noted however that the item search unit 130 uses the coordinate color ID and the coordinate design ID selected in step S118 as the coordinate color ID and the coordinate design ID.

A sixth case is a case of step S112-No and also step S122-Yes. In this case, the item search unit 130 searches for the recommended item similarly as in that method in the fourth case. It is noted however that the item search unit 130 uses the coordinate color ID and the coordinate design ID selected in step S118 as the coordinate color ID and the coordinate design ID.

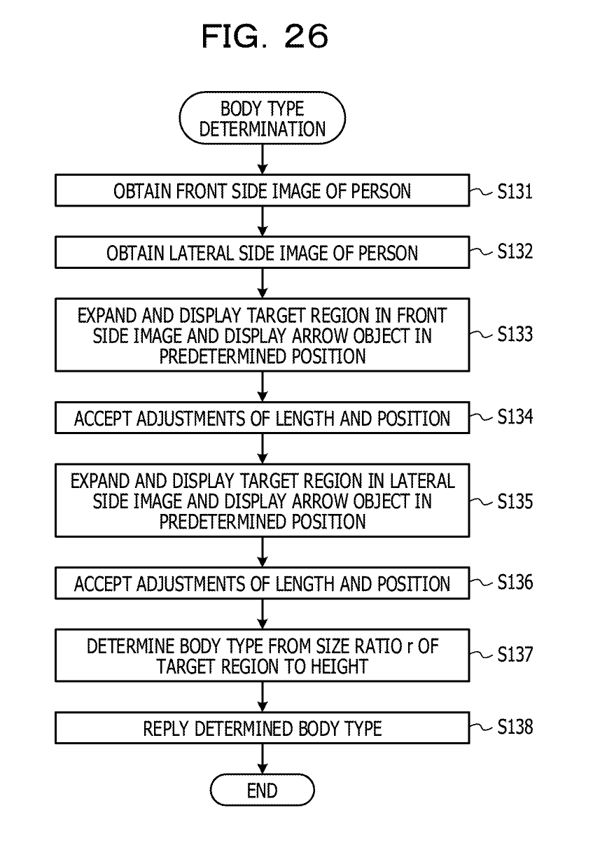

FIG. 26 is a flow chart illustrating the body type determination example according to the third exemplary embodiment. Hereinafter, the processing illustrated in FIG. 26 will be described along step numbers. The following procedure is equivalent to step S123 of FIG. 25.

(S131) The body type determination unit 140 obtains the front side image of the person (customer). Specifically, the body type determination unit 140 causes the display 105a to display the screen 710 and supports shooting of the front side image of the customer by the user (for example, the shop assistant). Subsequently, when the button 712 on the screen 710 is pressed, the body type determination unit 140 obtains the front side image of the customer captured by the camera 104.

(S132) The body type determination unit 140 obtains the lateral side image of the person (customer). Specifically, the body type determination unit 140 causes the display 105a to display the screen 720 and supports shooting of the lateral side image of the customer by the user (for example, the shop assistant). Subsequently, when the button 722 on the screen 720 is pressed, the body type determination unit 140 obtains the lateral side image of the customer captured by the camera 104.

(S133) The body type determination unit 140 expands and displays a target region of the front side image and displays an arrow object in a predetermined position. Specifically, the body type determination unit 140 causes the display 105a to display the screen 730. The screen 730 corresponds to an example of a case where the waist is used as the target region (region used for the body type determination).

(S134) The body type determination unit 140 accepts the adjustments of the length and the position of the arrow object 731 on the screen 730 by the user. Subsequently, the body type determination unit 140 obtains the length h1 of the arrow object 731 after the adjustments.

(S135) The body type determination unit 140 expands and displays the target region in the lateral side image and displays the arrow object in the predetermined position. Specifically, the body type determination unit 140 causes the display 105a to display the screen 740.

(S136) The body type determination unit 140 accepts adjustments on the length and the position of the arrow object 741 by the user on the screen 740. Subsequently, the body type determination unit 140 obtains the length h2 of the arrow object 741 after the adjustment.

(S137) The body type determination unit 140 refers to the body type master 114 stored in the master storage unit 110 and determines the body type category from the size ratio r of the target region (waist in this example) with respect to the height. As described above, the length w of the circumference of the ellipse having the length h1 set as the long axis and the length h2 set as the short axis can be regarded as the length corresponding to the waist of the customer. The body type determination unit 140 obtains the size ratio r=w/h0 with respect to the length h0 on the screen corresponding to the height of the customer. Subsequently, the body type determination unit 140 determines the body type category of the customer by collating the determination condition in the body type master 114 with the obtained size ratio r.

(S138) The body type determination unit 140 replies the determined body type category to the item search unit 130.

It is noted that the body type determination unit 140 may select the region used for the determination of the body type before the execution in step S131. For example, a shoulder width, busts, waist, hip, and the like are conceivable as candidates of the region used for the determination of the body type. At this time, the body type determination unit 140 may also select the region used for the determination of the body type in accordance with the selected product category. For example, the master storage unit 110 may previously store information of a correspondence relationship between the product categories and the regions for the body type determination in accordance with the product categories for the selection. With this configuration, the body type determination unit 140 refers to the information of the correspondence relationship stored in the master storage unit 110, and it is possible to select the region in accordance with the selected product category.

For example, in the case of the region where it is sufficient when only a length as viewed from the front side among the front side and the lateral side is found as in the shoulder width, the body type determination unit 140 may determine the body type category by omitting steps S132, S135, and S136.

Furthermore, in a case where the full-length image of the customer obtained in step S113 of FIG. 25 can also be used as the front side image of the customer or the lateral side image, the body type determination unit 140 may also skip one of steps S131 and S132. For example, the body type determination unit 140 may cause the display 105a to display the full-length image of the customer obtained in step S113 before the execution in step S131 and accept the selection on whether or not the full-length image is used as one of the front side image and the lateral side image. In this case, the body type determination unit 140 can skip the step of obtaining the selected image (one of step S131 and step S132).

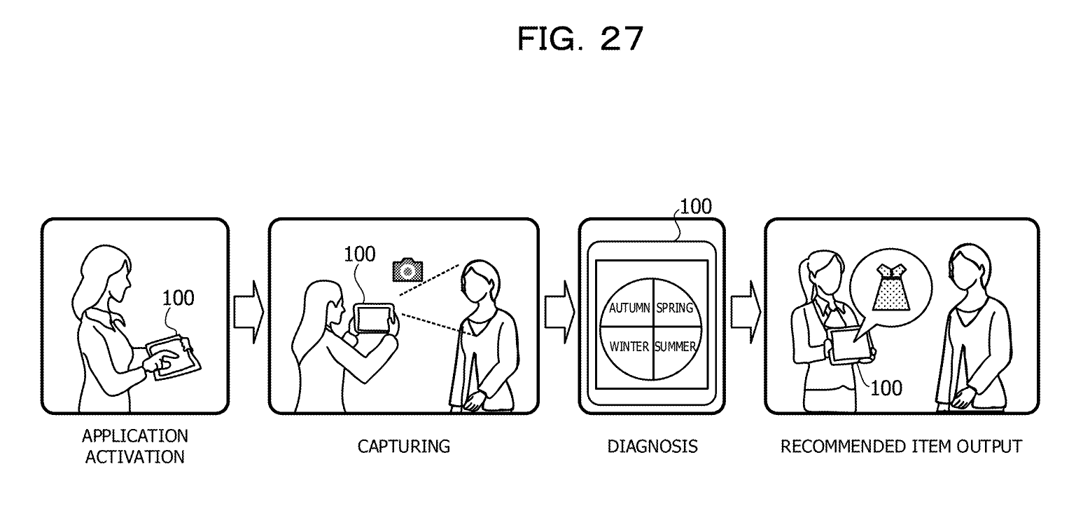

FIG. 27 illustrates a use example of the terminal according to the third exemplary embodiment. A shop assistant who performs customer support operates the terminal apparatus 100 to activate an application for supporting coordinate in a shop that sells clothing. The shop assistant inputs a product category of a product desired to be purchased by the customer and a gender of the customer to the terminal apparatus 100. Subsequently, the shop assistant operates the terminal apparatus 100 to capture a full-length image or a face image of the customer. The terminal apparatus 100 identifies a personal color of the customer based on the captured image and searches for an item having a suited color (recommended item) for the customer (this processing is referred to as a “diagnosis”) based on the personal color. The terminal apparatus 100 displays the recommended item. The shop assistant performs product suggestion while presenting the image of the recommended item displayed on the display 105a of the terminal apparatus 100 to the customer.

As a result, it becomes possible to support the appropriate selection of the objectively harmonizing color with respect to the customer. In addition, it is possible to avoid a forceful determination at the time of the color selection with respect to the customer or the shop assistant, and it is possible to save labor of the selection operation by the customer or the shop assistant.

Herein, the function of the terminal apparatus 100 can also be used in a scene other than the above-mentioned scene. For example, the terminal apparatus 100 may be used for proposals of dresses, Japanese-style clothing, or the like suited to the customer in a shop that deals with costumes for rent such as a wedding parlor or a photographic studio. While the dresses and the like having colors suited to the customer are narrowed down before trial fittings, the labor spent for the trial fittings of the customer and the costs on the shop side can be reduced.

Alternatively, the terminal apparatus 100 may also be configured to support product purchases by being accessed to an online shopping site. For example, the customer can casually find a product having a color suited to itself among products dealt with on the online shopping site based on the function of the terminal apparatus 100. In addition, while the clothing or the like having the color suited to the customer is presented, it is possible to suppress the misconception on colors by the customer and reduce the number of returns due to the misconception on colors.

In addition, since the recommended item is displayed by using the image according to the terminal apparatus 100, the terminal apparatus 100 is also useful in a case where a shop assistant who is not good at a foreign language performs the product proposal to a foreign customer.

It is noted that it is also conceivable that the body type determination unit 140 estimates a size of a predetermined region of the customer to be provided to the item search unit 130 in addition to the determination of the body type category of the customer. Furthermore, it is also conceivable that the item search unit 130 can also propose clothing having an appropriate size for the customer in addition to the color suited to the customer.

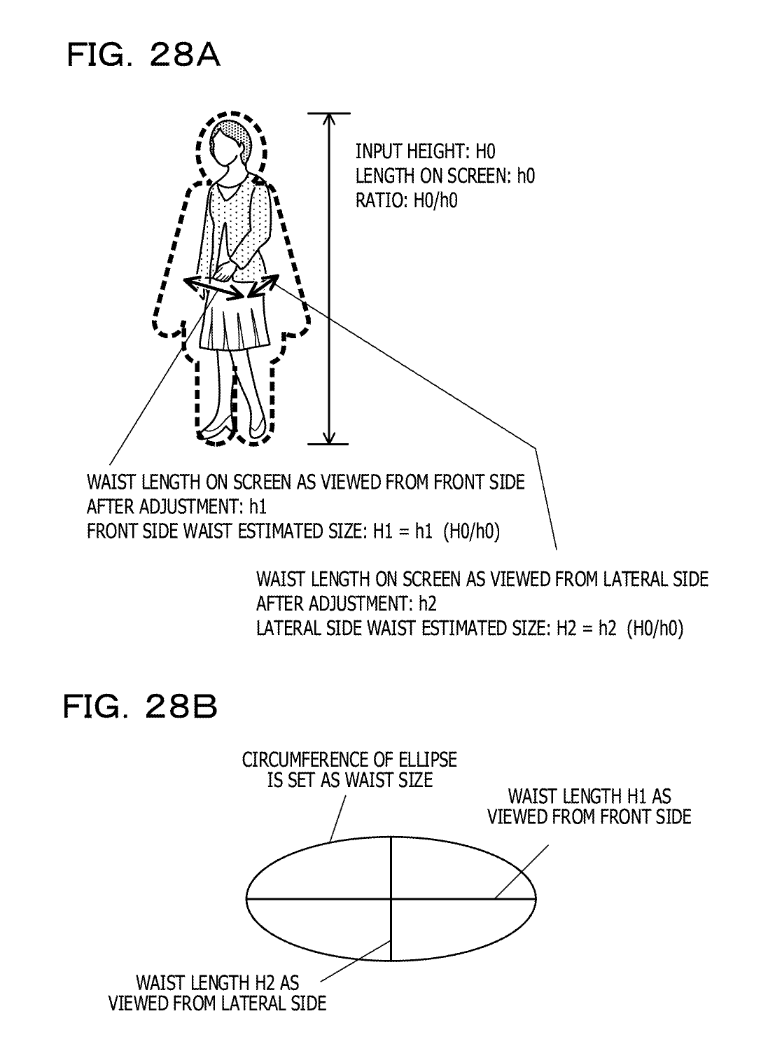

FIGS. 28A and 28B illustrate an example of a size estimation according to the third exemplary embodiment. FIG. 28A illustrates an estimation example of the height of the customer, the waist size as viewed from the front side, and the waist size as viewed from the lateral side. FIG. 28B illustrates an estimation example of the waist size of the customer.

For example, the body type determination unit 140 accepts an input of the height H0 of the customer. Subsequently, the body type determination unit 140 obtains a ratio H0/h0 of the length h0 on the screen corresponding to the height.

For example, the body type determination unit 140 calculates a front side waist estimated size H1=h1*(H0/h0) based on the length h1 of the waist as viewed from the front side after the adjustment by the arrow object 731. In addition, the body type determination unit 140 calculates a lateral side waist estimated size H2=h2*(H0/h0) based on the length h2 of the waist as viewed from the lateral side after the adjustment by the arrow object 741. Subsequently, the body type determination unit 140 obtains the length of the circumference of the ellipse in which the length of the long axis is H1 and the length of the short axis is H2 as the waist size of the customer. It is noted that the body type determination unit 140 may also obtain a value obtained by multiplying the above-mentioned length w by the ratio H0/h0 as the waist size of the customer.

In the above-mentioned example, the size is estimated while the waist is exemplified as the region, but various regions such as the shoulder width, busts, waist, hip, sleeve length, and leg length are conceivable as the region set as an estimation candidate of the size. In the case of the shoulder width, the sleeve length, and the leg length, the body type determination unit 140 can obtain the estimated size by obtaining a length on the screen as viewed from the front side and multiplying the length by the above-mentioned ratio H0/h0. The body type determination unit 140 provides the estimated size of the region to the item search unit 130.

Furthermore, for example, it is conceivable that identification information of sizes prepared for each product ID and product branch name (information equivalent to respective product size names such as S, M, and L) is registered in the product master 117. Specific sizes of the respective regions corresponding to the identification information of the sizes are individually defined, for example, as a size master in the master storage unit 110. The region where the size of the customer is to be considered may vary in accordance with products. For example, in the case of shirts, the shoulder width, the busts, and the sleeve length are conceivable as the region to be considered. Alternatively, in the case of bottoms, the hip and the leg length are conceivable as the regions to be considered.

With this configuration, the item search unit 130 can further identify the size matched with the region of the customer based on the product master 117 and the size master stored in the master storage unit 110 and the sizes of the respective regions estimated by the body type determination unit 140. In addition, the browser 120 displays the product having the size identified by the item search unit 130 as the recommended item.

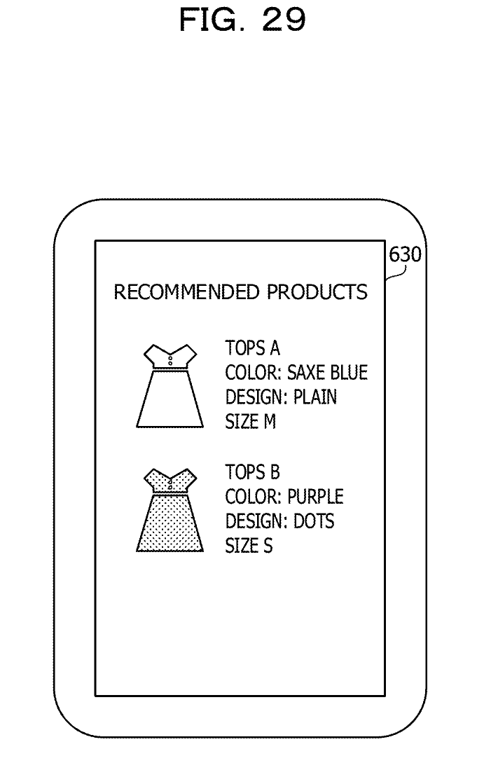

FIG. 29 illustrates another example the display contents according to the third exemplary embodiment. A screen 630 is a screen displayed on the display 105a instead of the screen 620 of FIG. 21 in a case where the narrowing-down operation of the recommended items is performed based on the body type of the customer. For example, the browser 120 displays the size matched with the customer among the sizes prepared for the relevant product together with the color and the design. As a result, the customer can more easily perform the selection of the product.

It is noted that the search function of the recommended item by the terminal apparatus 100 can be applied to not only a case where an item that a person puts on is selected but also a case where an item that an animal puts on is selected by a person, a case where an item to be installed in a living space is selected by a person, and the like.

In addition, the information processing according to the first exemplary embodiment can be realized when the processing unit 1b is caused to execute the program. In addition, the information processing according to the second exemplary embodiment can be realized when the processing unit 4b is caused to execute the program. Furthermore, the information processing according to the third exemplary embodiment can be realized when the processor 101 is caused to execute the program. The program can be recorded in the computer-readable recording media 12 and 23.

For example, the program can be circulated when the recording media 12 and 23 that record the program are distributed. The program may be stored in another computer (for example, the server 200) by using the recording medium 23, and the program may be distributed via a network. The computer may store (install) the program recorded in the recording medium 12 or the program received from the other computer in a storage device such as, for example, the RAM 102 or the flash memory 103 and read the program from the storage device to be executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes an information processing apparatus to execute a process, the process comprising:
obtaining a captured image in which an object person is included;
identifying a color classification corresponding to the object person based on the captured image;
obtaining, from a first storage unit that stores color information corresponding to the identified color classification, the color information corresponding to the color classification;
executing an obtaining processing for obtaining, from a second storage unit that stores an item and the color information while being associated with each other, item information indicating the item associated with the color information corresponding to the identified color classification; and
outputting the obtained item information.

2. The non-transitory computer-readable storage medium according to claim 1, the process further comprising:
receiving a first specification signal for specifying an item classification,
wherein the obtaining processing for obtaining the item information is processing for obtaining the item information indicating the item belonging to the specified item classification.

3. The non-transitory computer-readable storage medium according to claim 2, the process further comprising:
executing identification processing for identifying a color of a first part in the captured image,
wherein the obtaining processing is processing for obtaining the item information indicating the item that belongs to the specified item classification and is associated with the color information corresponding to a set of the color classification and the identified color of the first part.

4. The non-transitory computer-readable storage medium according to claim 3, wherein the identification processing is processing for displaying the captured image and a frame overlapped on the captured image, receiving a second specification signal for instructing a movement of the frame and a size change of the frame, and identifying the color of the first part included in a region surrounded by the frame.

5. The non-transitory computer-readable storage medium according to claim 1, the process further comprising:
determining a body type of the object person based on the captured image; and
obtaining the color information corresponding to the body type from a third storage unit that stores the color information and the body type while being associated with each other,
wherein the obtaining processing is processing of obtaining the item information indicating the item associated with the color information corresponding to both the color classification and the body type among the items belonging to the item classification.

6. The non-transitory computer-readable storage medium according to claim 1, the process further comprising:
determining a body type of the object person based on the captured image
wherein the obtaining processing is processing of obtaining, from the first storage unit that stores first information in which the item and the color information are associated with design information and second information in which the design information is associated with the body type, the item information indicating the item that belongs to the item classification and is associated with both the color information corresponding to the color classification and the design information corresponding to the body type.

7. The non-transitory computer-readable storage medium according to claim 1, the process further comprising:
identifying a first design of a first part in the captured image; and
identifying a second design corresponding to the first design based on combination information indicating a combination of a plurality of designs,
wherein the obtaining processing is processing of obtaining the item information indicating the item that belongs to an item classification and is associated with the color information corresponding to the color classification and the second design.

8. An information processing apparatus comprising:
a memory; and
a processor coupled to the memory and configured to:
obtain a captured image in which an object person is included,
identify a color classification corresponding to the object person based on the captured image,
obtain, from a first storage unit that stores color information corresponding to the identified color classification, the color information corresponding to the color classification,
execute an obtaining processing for obtaining, from a second storage unit that stores an item and the color information while being associated with each other, item information indicating the item associated with the color information corresponding to the identified color classification, and
output the obtained item information.

9. The information processing apparatus according to claim 8, wherein the processor is further configured to:
receive a first specification signal for specifying an item classification,
wherein the obtaining processing for obtaining the item information is processing for obtaining the item information indicating the item belonging to the specified item classification.

10. The information processing apparatus according to claim 9, wherein the processor is further configured to:
execute identification processing for identifying a color of a first part in the captured image,
wherein the obtaining processing is processing for obtaining the item information indicating the item that belongs to the specified item classification and is associated with the color information corresponding to a set of the color classification and the identified color of the first part.

11. The information processing apparatus according to claim 10, wherein the identification processing is processing for displaying the captured image and a frame overlapped on the captured image, receiving a second specification signal for instructing a movement of the frame and a size change of the frame, and identifying the color of the first part included in a region surrounded by the frame.

12. The information processing apparatus according to claim 8, the processor is further configured to:
determine a body type of the object person based on the captured image, and
obtain the color information corresponding to the body type from a third storage unit that stores the color information and the body type while being associated with each other,
wherein the obtaining processing is processing of obtaining the item information indicating the item associated with the color information corresponding to both the color classification and the body type among the items belonging to the item classification.

13. The information processing apparatus according to claim 8, the processor is further configured to:
determine a body type of the object person based on the captured image,
wherein the obtaining processing is processing of obtaining, from the first storage unit that stores first information in which the item and the color information are associated with design information and second information in which the design information is associated with the body type, the item information indicating the item that belongs to the item classification and is associated with both the color information corresponding to the color classification and the design information corresponding to the body type.

14. The information processing apparatus according to claim 8, the processor is further configured to:
identify a first design of a first part in the captured image, and
identify a second design corresponding to the first design based on combination information indicating a combination of a plurality of designs,
wherein the obtaining processing is processing of obtaining the item information indicating the item that belongs to an item classification and is associated with the color information corresponding to the color classification and the second design.

15. A method executed by an information processing apparatus, the method comprising:
obtaining a captured image in which an object person is included;
identifying a color classification corresponding to the object person based on the captured image;
obtaining, from a first storage unit that stores color information corresponding to the identified color classification, the color information corresponding to the color classification;
executing an obtaining processing for obtaining, from a second storage unit that stores an item and the color information while being associated with each other, item information indicating the item associated with the color information corresponding to the identified color classification; and
outputting the obtained item information.

16. The method according to claim 15 further comprising:
receiving a first specification signal for specifying an item classification,
wherein the obtaining processing for obtaining the item information is processing for obtaining the item information indicating the item belonging to the specified item classification.

17. The method according to claim 16 further comprising:
executing identification processing for identifying a color of a first part in the captured image,
wherein the obtaining processing is processing for obtaining the item information indicating the item that belongs to the specified item classification and is associated with the color information corresponding to a set of the color classification and the identified color of the first part.

18. The method according to claim 17, wherein the identification processing is processing for displaying the captured image and a frame overlapped on the captured image, receiving a second specification signal for instructing a movement of the frame and a size change of the frame, and identifying the color of the first part included in a region surrounded by the frame.

19. The method according to claim 15 further comprising:
determining a body type of the object person based on the captured image; and
obtaining the color information corresponding to the body type from a third storage unit that stores the color information and the body type while being associated with each other,
wherein the obtaining processing is processing of obtaining the item information indicating the item associated with the color information corresponding to both the color classification and the body type among the items belonging to the item classification.

20. The method according to claim 15 further comprising:
determining a body type of the object person based on the captured image,
wherein the obtaining processing is processing of obtaining, from the first storage unit that stores first information in which the item and the color information are associated with design information and second information in which the design information is associated with the body type, the item information indicating the item that belongs to the item classification and is associated with both the color information corresponding to the color classification and the design information corresponding to the body type.
